(19) United States
(12) Patent Application Publication
(10) Pub. No.: US 2025/0209679 A1
(43) Pub. Date: Jun. 26, 2025

(54) IMAGE PROCESSING APPARATUS AND IMAGE PROCESSING SYSTEM

(71) Applicant: SONY GROUP CORPORATION, TOKYO (JP)

(72) Inventor: MASATO SHIMAKAWA, TOKYO (JP)

(21) Appl. No.: 18/848,918

(22) PCT Filed: Mar. 15, 2023
(86) PCT No.: PCT/JP2023/010002

§ 371 Date: Sep. 20, 2024

(30) Foreign Application Priority Data
Mar. 31, 2022 (JP) 2022-057854

(51) Int. Cl. G06T 11/00

(52) U.S. Cl. CPC G06T 11/00

(57) ABSTRACT

The present disclosure relates to an image processing apparatus and an image processing system capable of realizing 2D delivery capable of producing a realistic feeling at low cost. The image processing apparatus includes a 2D video generation unit that acquires, as virtual viewpoint information, camera positional information of a camera that performs imaging at a first place, and generates a 2D video obtained by viewing a 3D model of a person generated by performing imaging at a second place different from the first place from a viewpoint of the camera. The technique of the present disclosure can be applied to, for example, an image processing system that delivers a 2D video using volumetric capture.

### TECHNICAL FIELD

The present disclosure relates to an image processing apparatus and an image processing system, and more particularly to an image processing apparatus and an image processing system capable of realizing 2D delivery that can produce a realistic feeling at low cost.

### BACKGROUND ART

There is a technique for providing a video of a free viewpoint by generating a 3D model of a subject from a moving image imaged from multiple viewpoints and generating a virtual viewpoint video of the 3D model corresponding to any viewpoint (virtual viewpoint) (see, for example, Patent Document 1). This technique is also called volumetric capture or the like. There are a method in which a user of a delivery destination determines the virtual viewpoint for the 3D model of the subject and the video is delivered such that each user can freely change the viewpoint (hereinafter, referred to as 3D delivery.) and a method in which a delivery side determines the virtual viewpoint and delivers the video of the same virtual viewpoint to a plurality of users (hereinafter, referred to as 2D delivery.).

As a method for synthesizing a foreground video and a background video, for example, there is a chroma key synthesizing technique of synthesizing a foreground video obtained by imaging a person in a studio and a background video (see, for example, Patent Document 2).

### CITATION LIST

### Patent Document

Patent Document 1: WO 2018/150933
Patent Document 2: Japanese Patent Application Laid-Open No. 2012-175128

### SUMMARY OF THE INVENTION

### Problems to be Solved by the Invention

In the above-described 2D delivery, when it is attempted to synthesize the foreground video of the 3D model by the volumetric capture and the background video generated by a 3D CG video, it takes a long time to produce the 3D CG video, and large cost is generated. Furthermore, when the 3D CG video is used as a background, the person in the foreground is realistic like a real image by volumetric capture, whereas the background video lacks realism. Furthermore, in a case where the background video based on the 3D CG video created in advance is synthesized, it looks like a video recorded in advance, and it is difficult to produce a live feeling.

The present disclosure has been made in view of such a situation, and an object thereof is to realize 2D delivery capable of producing realistic feeling at low cost.

### Solutions to Problems

An image processing apparatus according to a first aspect of the present disclosure includes a 2D video generation unit that acquires, as virtual viewpoint information, camera positional information of a camera that performs imaging at a first place, and generates a 2D video obtained by viewing a 3D model of a person generated by performing imaging at a second place different from the first place from a viewpoint of the camera.

An image processing system according to a second aspect of the present disclosure includes a 2D video generation device that acquires, as virtual viewpoint information, camera positional information of a camera that performs imaging at a first place, and generates a 2D video obtained by viewing a 3D model of a person generated by performs imaging at a second place different from the first place from a viewpoint of the camera, and a video synthesizing device that generates a synthesized image obtained by synthesizing a 2D video generated by the 2D video generation device and a 2D video generated by the camera.

In the first and second aspects of the present disclosure, the camera positional information of the camera that performs imaging at the first place is acquired as the virtual viewpoint information, and the 2D video obtained by viewing the 3D model of the person generated by performing imaging at the second place different from the first place from the viewpoint of the camera is generated. Moreover, in the second aspect of the present disclosure, the synthesized image is generated by synthesizing the 2D video generated by the 2D video generation device and the 2D video generated by the camera.

Note that, each of the first image processing system and the image processing system according to the second aspect of the present disclosure can be realized by causing a computer to execute a program. The program executed by the computer can be provided by being transmitted via a transmission medium or by being recorded on a recording medium.

The image processing apparatus and the image processing system may be independent apparatuses or may be inner blocks including one device.

### BRIEF DESCRIPTION OF DRAWINGS

FIG. 1 is a diagram for describing an outline of volumetric capture.

FIG. 2 is a diagram for describing the outline of the volumetric capture.

FIG. 3 is a block diagram for describing a first embodiment of an image processing system to which the present technology is applied.

FIG. 4 is a diagram for describing delivery of a synthesized video by the image processing system in FIG. 3.

FIG. 5 is a diagram for describing the delivery of the synthesized video by the image processing system in FIG. 3.

FIG. 6 is a diagram for describing the delivery of the synthesized video by the image processing system in FIG. 3.

FIG. 7 is a diagram for describing the delivery of the synthesized video by the image processing system in FIG. 3.

FIG. 8 is a diagram for describing the delivery of the synthesized video by the image processing system in FIG. 3.

FIG. 9 is a flowchart for describing volumetric video generation processing.

FIG. 10 is a flowchart for describing volumetric 2D video generation processing.

FIG. 11 is a flowchart for describing synthesized video generation processing.

FIG. 12 is a flowchart for describing details of video synthesis processing in step S54 of FIG. 11.

FIG. 13 is a diagram comparing the image processing system of FIG. 3 with another system.

FIG. 14 is a block diagram illustrating a variation of the first embodiment of the image processing system.

FIG. 15 is a block diagram illustrating a first configuration example of a second embodiment of the image processing system to which the present technology is applied.

FIG. 16 is a diagram for describing an operation of the first configuration example of the second embodiment.

FIG. 17 is a block diagram illustrating a second configuration example of a second embodiment of the image processing system to which the present technology is applied.

FIG. 18 is a diagram illustrating an example of a delivery video according to a second configuration example of the second embodiment.

FIG. 19 is a block diagram illustrating a third configuration example of the second embodiment of the image processing system to which the present technology is applied.

FIG. 20 is a diagram illustrating an example of the synthesized video according a third configuration example of the second embodiment.

FIG. 21 is a block diagram illustrating a third embodiment of the image processing system to which the present technology is applied.

FIG. 22 is a diagram for describing an origin operation in each coordinate setting mode.

FIG. 23 is a diagram for describing origin processing in each coordinate setting mode.

FIG. 24 is a diagram for describing a control example of a camera position of virtual viewpoint information in each coordinate setting mode.

FIG. 25 is a diagram illustrating an example of a mode selection button and an origin position designation button.

FIG. 26 is a flowchart for describing virtual viewpoint information generation processing by a background video device of the third embodiment.

FIG. 27 is a diagram illustrating a configuration example using a smartphone or a drone as a real camera.

FIG. 28 is a block diagram illustrating a fourth embodiment of the image processing system to which the present technology is applied.

FIG. 29 is a diagram for describing illuminance information acquired by an illumination sensor and illumination control information for controlling an illumination device.

FIG. 30 is a flowchart for describing illumination control processing by an image processing system 1 of the fourth embodiment.

FIG. 31 is a block diagram illustrating a fifth embodiment of the image processing system to which the present technology is applied.

FIG. 32 is a diagram illustrating a disposition example of an omnidirectional camera and a wall surface display.

FIG. 33 is a flowchart for describing omnidirectional video output processing by an omnidirectional video output device of the fifth embodiment.

FIG. 34 is a flowchart for describing reprojection processing of an omnidirectional video in step S152 of FIG. 33.

FIG. 35 is a block diagram illustrating a configuration example of an embodiment of a computer to which the technique of the present disclosure is applied.

### MODE FOR CARRYING OUT THE INVENTION

Hereinafter, modes for carrying out the technique of the present disclosure (hereinafter, referred to as embodiments) will be described with reference to the accompanying drawings. Note that, in the present specification and the drawings, components having substantially the same functional configurations are denoted by the same reference signs, and redundant descriptions are omitted. The description is given in the following order.
1. Overview of Volumetric Capture
2. First Embodiment of Image Processing System
3. delivery of Synthesized Video by Image Processing System
4. Volumetric Video Generation Processing
5. Volumetric 2D Video Generation Processing
6. Synthesized Video Generation Processing
7. Comparison with Other Systems
8. Variation of First Embodiment
9. Second embodiment of Image Processing System
10. Third Embodiment of Image Processing System
11. Fourth Embodiment of Image Processing System
12. Fifth Embodiment of Image Processing System
13. Summary of Image Processing System of Present Disclosure
14. Computer configuration example

### 1. Overview of Volumetric Capture

An image processing system of the present disclosure relates to volumetric capture that provides a video of a free viewpoint (free viewpoint video) by generating a 3D model of a subject from a moving image imaged from multiple viewpoints and generating a virtual viewpoint video of the 3D model corresponding to any viewing position.

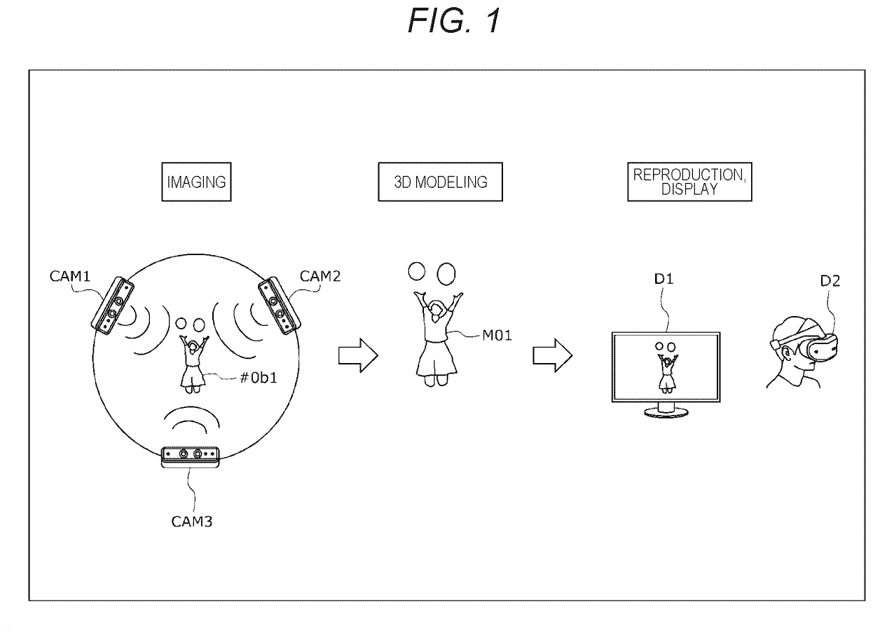

Accordingly, first, the generation of the 3D model of the subject and display of the free viewpoint video using the 3D model will be briefly described with reference to FIG. 1.

For example, a plurality of imaged images can be obtained by imaging a predetermined imaging space in which a subject such as a person is disposed by a plurality of image imaging devices from an outer periphery thereof. The imaged image includes, for example, a moving image. In the example of FIG. 1, three imaging devices CAM1 to CAM3 are disposed to surround a subject #Ob1, but the number of imaging devices CAMs is not limited to three and is an any number. Since the number of imaging devices CAM at the time of imaging is the known number of viewpoints when the free viewpoint video is generated, the free viewpoint video can be expressed with higher accuracy as the number is larger. The subject #Ob1 is a person performing a predetermined motion.

A 3D object MO1, which is a 3D model of the subject #Ob1 to be displayed in the imaging space, is generated by using imaged images obtained from a plurality of imaging devices CAM in different directions (3D modeling). The 3D object MO1 can be generated by using, for example, a method such as a visual hull in which a three-dimensional shape of the subject is cut out by using imaged images in the different directions.

Then, the 3D object is rendered by using data (hereinafter, also referred to as 3D model data.) of one or more 3D objects among one or more 3D objects present in the imaging space, a 2D video displayed on a viewing device of a viewer is displayed. FIG. 1 illustrates an example in which the viewing device is a display D1 or a head mounted display (HMD) D2.

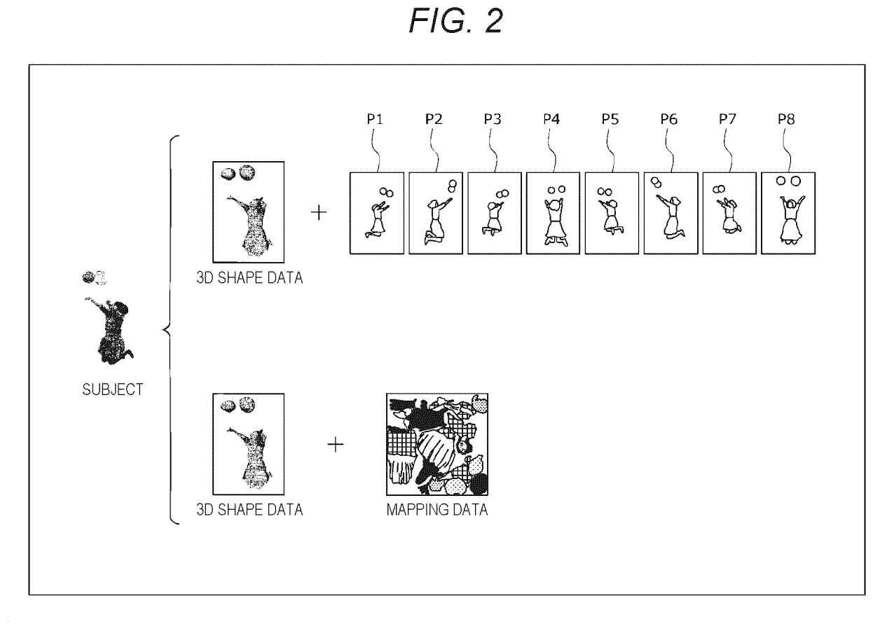

FIG. 2 illustrates an example of a data format of general 3D model data.

The 3D model data is generally expressed by 3D shape data representing a 3D shape (geometry information) of the subject and texture data representing color information of the subject.

The 3D shape data is expressed in, for example, a point cloud format in which a three-dimensional position of the subject is represented by a set of points, a 3D mesh format in which the three-dimensional position of the subject is represented by vertexes called polygon mesh and connections between the vertexes, a voxel format in which the three-dimensional position of the subject is represented by a set of cubes called voxels, and the like.

Examples of the texture data include a multi-texture format retained in an imaged image (two-dimensional texture image) imaged by each imaging device CAM, and a UV mapping format retained by expressing a two-dimensional texture image attached to each point or each polygon mesh as 3D shape data in a UV coordinate system.

As illustrated in an upper part of FIG. 2, a format in which the 3D model data is described in the 3D shape data and the multi-texture format retained in a plurality of imaged images P1 to P8 imaged by the imaging devices CAM is a view dependent format in which color information can change depending on the virtual viewpoint (position of a virtual camera).

On the other hand, as illustrated in a lower part of FIG. 2, a format in which the 3D model data is described by the 3D shape data and the UV mapping format in which texture information of the subject is mapped on the UV coordinate system is a view independent format in which the color information is the same depending on the virtual viewpoint (position of the virtual camera).

### 2. First Embodiment of Image Processing System

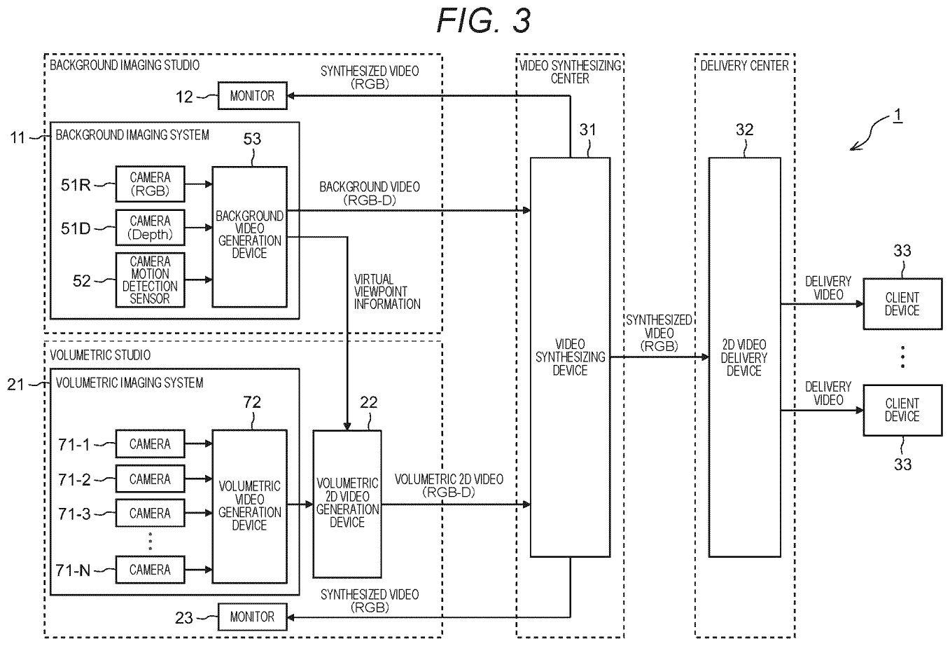

FIG. 3 is a block diagram illustrating a first embodiment of an image processing system to which the present technology is applied.

An image processing system 1 of FIG. 3 is a video delivery system that delivers a synthesized video obtained by synthesizing a video of a subject (for example, person) imaged in a volumetric studio and a background video imaged in a background imaging studio.

A background imaging system 11 and a monitor 12 of the image processing system 1 are installed in the background imaging studio. Furthermore, a volumetric imaging system 21, a volumetric 2D video generation device 22, and a monitor 23 of the image processing system 1 are installed in the volumetric studio. Moreover, the image processing system 1 includes a video synthesizing device 31 and a 2D video delivery device 32, the video synthesizing device 31 is installed in a video synthesizing center, and the 2D video delivery device 32 is installed in a delivery center.

The image processing system 1 delivers, to a client device 33 of a user, a synthesized video obtained by synthesizing a video imaged by a real camera (actual camera) as a background video and a 2D video of a person generated by using a volumetric capture technique in the volumetric studio. Both the video of the person imaged in the volumetric studio and the background video imaged in the background imaging studio are generated as moving images in real time (immediately) and at the same time. The synthesized video is also generated in real time as a moving image and is delivered, as a delivery video, to the client device 33. Note that, the delivery to the client device 33 may be delivered (on demand) in response to a request from the user.

The background imaging studio, the volumetric studio, the video synthesizing center, and the delivery center may be disposed close to each other in the same building, or may be disposed far away from each other, for example. Data can be transmitted and received via, for example, a predetermined network such as a local area network, the Internet, a public telephone line network, a mobile communication network for a wireless mobile body such as a so-called 4G line or 5G line, a digital satellite broadcasting network, or a television broadcasting network.

A place of the background imaging system 11 is an indoor background imaging studio for the sake of simplicity, but is not limited to indoors, and may be an outdoor imaging environment called a location site, for example. Furthermore, the video imaged in the background imaging studio is assumed to image a background video of a person in the volumetric studio, but a part of the video may be a foreground of the person in the volumetric studio.

The background imaging system 11 of the background imaging studio includes a camera 51R, a camera 51D, a camera motion detection sensor 52, and a background video generation device 53.

The camera 51R is an imaging device that images a color (RGB) 2D video as the background video. The camera 51D is an imaging device that detects a depth value (distance information) to a subject imaged by the camera 51R and generates a depth video in which the detected depth value is stored as a pixel value. The camera 51D is adjusted and installed such that an optical axis coincides with the camera 51R. The camera 51R and the camera 51D may be one combined imaging device.

In the following description, description will be described with the camera 51D as an RGB camera 51R and the camera 51D as a depth camera 51D in order to facilitate distinction. Furthermore, in a case where the RGB camera 51R and the depth camera 51D are integrally expressed, these cameras will be described as a real camera 51.

The camera motion detection sensor 52 is a sensor that acquires camera positional information of the real camera 51. The camera positional information includes a position of the real camera 51 represented by three-dimensional coordinates of (x, y, z) with a predetermined origin as a reference, an orientation of the real camera 51 represented by (pan, tilt, roll), and a zoom value represented by a value from 0 to 100%. “pan” represents an orientation in a left-right direction, “tilt” represents an orientation in an up-down direction, and “roll” represents rotation around the optical axis. The camera motion detection sensor 52 is attached to a movable unit such as a camera platform, for example. Sensors that acquire the camera position, the camera orientation, and the zoom value may be individually provided as the camera motion detection sensor 52.

The background video generation device 53 performs adjustment such that the 2D video supplied from the RGB camera 51R and the depth video supplied from the depth camera 51D have the same angle of view. Then, the background video generation device 53 assigns a background imaging system ID and a frame number (FrameNo) to a 2D video and a depth video after the angle of view is adjusted, and supplies the 2D video and the depth video to the video synthesizing device 31. Hereinafter, in order to facilitate distinction from others, the 2D video and the depth video supplied from the background video generation device 53 to the video synthesizing device 31 are referred to as a background video (RGB) and a background video (Depth), respectively, and a set of the background video (RGB) and the background video (Depth) is referred to as a background video (RGB-D).

Furthermore, the background video generation device 53 assigns the background imaging system ID and the frame number to the position, orientation, and zoom value of the real camera 51 supplied from the camera motion detection sensor 52, and supplies, as virtual viewpoint information, the position, orientation, and zoom value to the volumetric 2D video generation device 22. For the transmission of the virtual viewpoint information, any protocol may be used, and for example, a FreeD protocol used for creation of AR/VR content can be used.

The monitor 12 displays the synthesized video (RGB) supplied from the video synthesizing device 31 in the video synthesizing center. The synthesized video (RGB) displayed on monitor 12 is a color (RGB) 2D video, and is the same video as the synthesized video (RGB) transmitted from the video synthesizing device 31 to the 2D video delivery device 32. The synthesized video (RGB) displayed on monitor 12 is a video to be confirmed by a person who is a performer of the background imaging studio.

The volumetric imaging system 21 of the volumetric studio includes N (N>1) cameras 71-1 to 71-N and a volumetric video generation device 72.

The cameras 71-1 to 71-N are disposed around an imaging area to surround the person in the volumetric studio. Each of the cameras 71-1 to 71-N images the person who is the subject, and supplies the imaged images obtained as a result to the volumetric video generation device 72. Camera parameters (external parameters and internal parameters) including installation places of the cameras 71-1 to 71-N are known and supplied to the volumetric video generation device 72.

The volumetric video generation device 72 generates the 3D model of the person in the volumetric studio from the imaged images supplied from the cameras 71-1 to 71-N by using the volumetric capture technique. The volumetric video generation device 72 supplies the generated 3D model data of the person to the volumetric 2D video generation device 22. As described above, the 3D model data of the person includes the 3D shape data and the texture data.

The volumetric 2D video generation device 22 acquires the virtual viewpoint information from the background video generation device 53, and acquires the 3D model data of the person in the volumetric studio from the volumetric video generation device 72. The virtual viewpoint information includes the background imaging system ID and the frame number.

The volumetric 2D video generation device 22 generates a 2D video and a depth video obtained by viewing the 3D model of the person in the volumetric studio from the virtual camera based on the virtual viewpoint information, assigns the same background imaging system ID and frame number as the virtual viewpoint information, and supplies the 2D video and the depth video to the video synthesizing device 31. In order to distinguish from the background video (RGB) and the background video (Depth) described above, the 2D video and the depth video supplied from the volumetric 2D video generation device 22 to the video synthesizing device 31 are described as a volumetric 2D video (RGB) and a volumetric 2D video (Depth), respectively, and a set of the volumetric 2D video (RGB) and the volumetric 2D video (Depth) is described as a volumetric 2D video (RGB-D).

The monitor 23 displays the synthesized video (RGB) supplied from the video synthesizing device 31 in the video synthesizing center. The synthesized video (RGB) displayed on the monitor 23 is a color (RGB) 2D video, and is the same video as the synthesized video (RGB) transmitted from the video synthesizing device 31 to the 2D video delivery device 32. The synthesized video (RGB) displayed on the monitor 23 is a video to be confirmed by a person who is a performer of the volumetric studio.

The video synthesizing device 31 generates the synthesized video (RGB) by synthesizing the background video (RGB-D) from the background video generation device 53 and the volumetric 2D video (RGB-D) from the volumetric 2D video generation device 22, which have the same background imaging system ID and frame number. Specifically, the video synthesizing device 31 compares the depth value of the background video (RGB-D) at the same pixel position with the depth value of the volumetric 2D video (RGB-D), and generates the synthesized video (RGB) to give a priority to a closer subject. The synthesized video (RGB) is the color (RGB) 2D video. The video synthesizing device 31 supplies the generated synthesized video (RGB) to the 2D video delivery device 32, and also supplies the synthesized video to the monitor 12 of the background imaging studio and the monitor 23 of the volumetric studio.

The 2D video delivery device 32 transmits (delivers), as the delivery video, the synthesized video (RGB) sequentially supplied from the video synthesizing device 31 to one or more client devices 33 via a predetermined network. The delivery from the 2D video delivery device 32 to each client device 33 can be performed, for example, via a predetermined network such as the Internet, a mobile communication network for a wireless mobile body such as a so-called 4G line or 5G line, a digital satellite broadcasting network, or a television broadcasting network.

The client device 33 includes, for example, a personal computer, a smartphone, or the like, acquires the synthesized video (RGB) from the 2D video delivery device 32 via a predetermined network, and displays the synthesized video on a predetermined display device. For example, the 2D video delivery device 32 compresses the synthesized video (RGB) sequentially supplied from the video synthesizing device 31 every time intervals, and disposes the synthesized video in a delivery server such that the synthesized video can be accessed from the client device 33 via a content delivery network (CDN). The client device 33 acquires and reproduces the synthesized video (RGB) placed on the delivery server via the CDN.

Each of the background video generation device 53, the volumetric video generation device 72, the volumetric 2D video generation device 22, the video synthesizing device 31, and the 2D video delivery device 32 can be constituted by, for example, a server device, a dedicated image processing apparatus, or the like.

The image processing system 1 of the first embodiment has the above configuration.

### 3. Delivery of Synthesized Video by Image Processing System

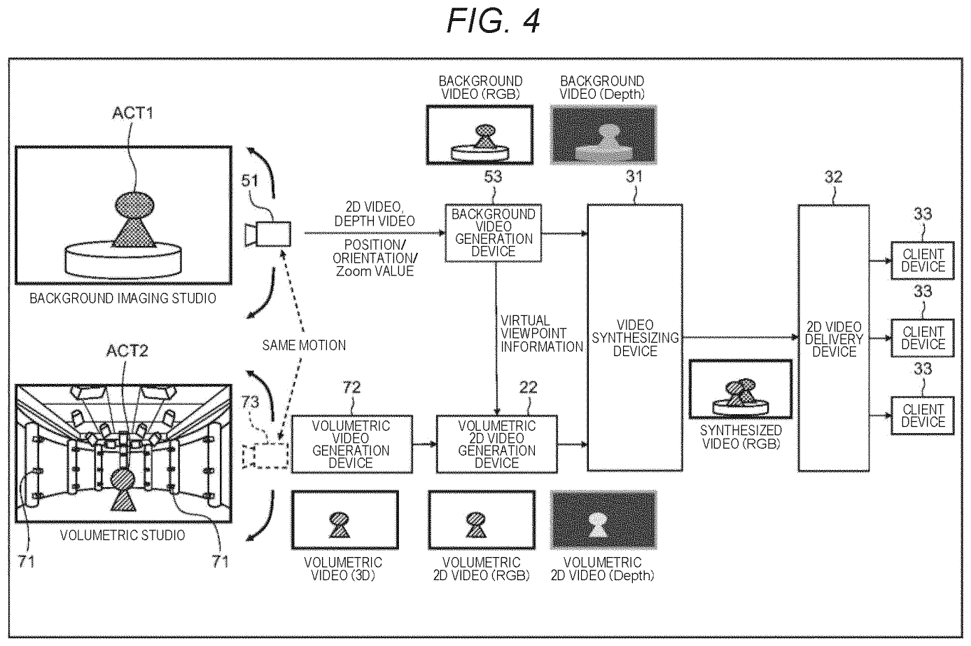

The delivery of the synthesized video by the image processing system 1 will be described with reference to FIGS. 4 to 8.

FIG. 4 illustrates a flow of processing from the imaging in the background imaging studio and the volumetric studio to the delivery of the synthesized video to the client device 33.

First, a predetermined position is set as an origin position in each of the background imaging studio and the volumetric studio. Any method may be used as a method for setting the origin position. For example, it is possible to use a method for moving the real camera 51 to a place desired to be set as an origin in the background imaging studio and pressing an origin setting button to set a current position of the real camera 51 as the origin. In the volumetric studio, a predetermined position is also set as the origin position by a similar method or a different method.

In the background imaging studio, the real camera 51 images a person ACT as a subject and a background thereof. More specifically, the RGB camera 51R images the person ACT1 and the background thereof, and outputs a 2D video obtained as a result to the background video generation device 53. The depth camera 51D detects distances to the person ACT1 and the background, and outputs the depth video to the background video generation device 53. The camera motion detection sensor 52 acquires the position, orientation, and zoom value of the real camera 51, and outputs the acquired position, orientation, and zoom value to the background video generation device 53.

The background video generation device 53 performs adjustment such that the 2D video and the depth video have the same angle of view. A 2D video and a depth video after the angle of view is adjusted are a background video (RGB) and a background video (Depth). A background imaging system ID and a frame number are assigned to the background image (RGB) and the background image (Depth), and are output from the background video generation device 53 to the video synthesizing device 31.

Furthermore, the background video generation device 53 assigns the background imaging system ID and the frame number to the position, orientation, and zoom value of the real camera 51 supplied from the camera motion detection sensor 52, and outputs, as the virtual viewpoint information, the position, orientation, and zoom value to the volumetric 2D video generation device 22.

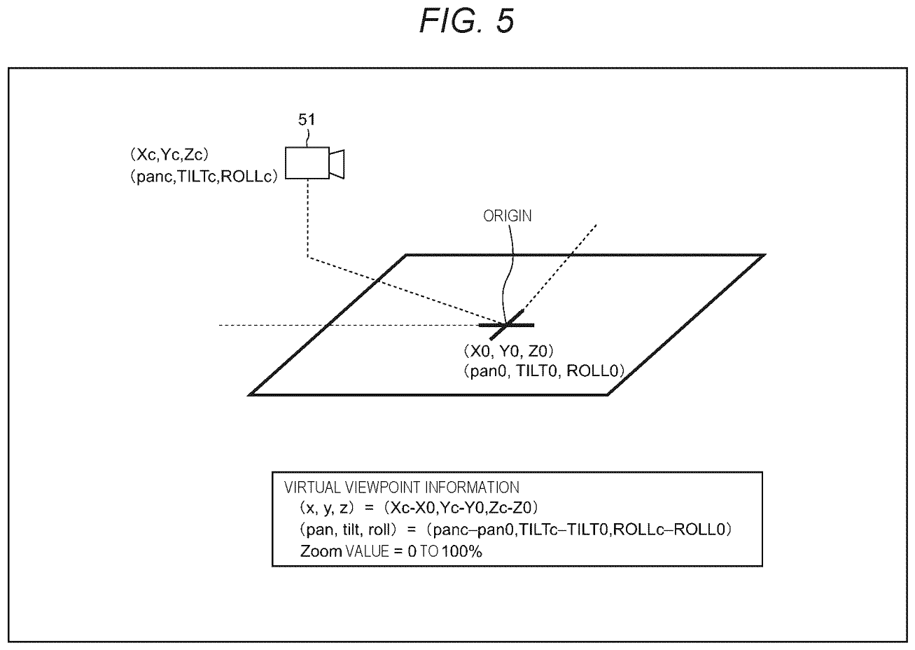

FIG. 5 illustrates an output example of the virtual viewpoint information.

The origin position is set to position (x, y, z)=(X0, Y0, Z0) and orientation (pan, tilt, roll)=(pan0, TILT0, ROLL0). After the origin is set, in a case where the camera motion detection sensor 52 detects, as a position (Xc, Yc, Zc) and an orientation (panc, TILTc, ROLLc), the position and orientation of the real camera 51, the background video generation device 53 calculates the virtual viewpoint information as follows and outputs the virtual viewpoint information to the volumetric 2D video generation device 22.

Position (x,y,z)=(Xc−X0,Yc−Y0,Zc−Z0)

Orientation (pan,tilt,roll)=(panc−pan0,TILTc−TILT0,ROLLc−ROLL0)

Zoom value=predetermined value within range of 0 to 100[%]

Referring back to FIG. 4, in the volumetric studio, a plurality of cameras 71 (cameras 71-1 to 71-N) installed on an outer periphery of the studio images a person ACT2 as the subject, and outputs an imaged image obtained as a result to the volumetric video generation device 72. In order to facilitate distinction between the person ACT2 who is a performer of a 3D model data generation target and the others, the volumetric studio is green back.

The volumetric video generation device 72 generates the 3D model of the person ACT2 from the imaged images supplied from the plurality of cameras 71 by using the volumetric capture technique. The volumetric video generation device 72 outputs the generated 3D model data of the person ACT2 to the volumetric 2D video generation device 22.

The volumetric 2D video generation device 22 generates a 2D video and a depth video obtained by viewing the 3D model of the person ACT2 from the volumetric video generation device 72 from a virtual camera 73. Here, the volumetric 2D video generation device 22 uses, as a viewpoint of the virtual camera 73, the virtual viewpoint information supplied from the background video generation device 53. That is, the volumetric 2D video generation device 22 matches the position, orientation, and zoom value of the virtual camera 73 with the real camera 51, and generates a 2D video and a depth video obtained by viewing the 3D model of the person ACT2 from the viewpoint of the real camera 51. The 2D video and the depth video are a volumetric 2D video (RGB) and a volumetric 2D video (Depth).

The volumetric 2D video generation device 22 generates a volumetric 2D video (RGB) and a volumetric 2D video (Depth) of the same viewpoint as the real camera 51 by using the 3D model data of the person ACT2, assigns the same background imaging system ID and frame number as the virtual viewpoint information, and outputs the volumetric 2D video (RGB) and the volumetric 2D video (Depth) to the video synthesizing device 31.

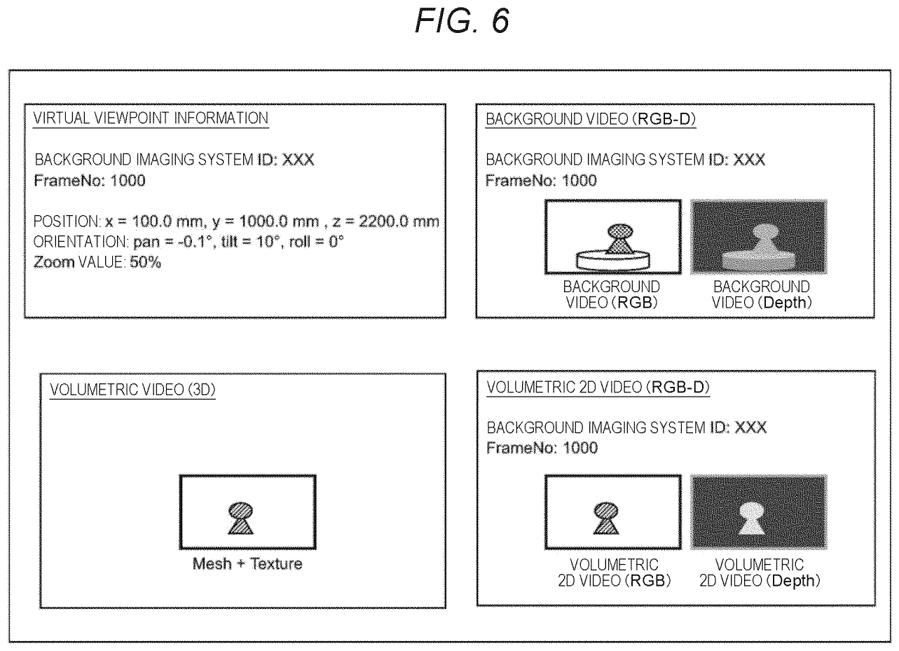

FIG. 6 illustrates an example of pieces of data generated by the background video generation device 53, the volumetric video generation device 72, and the volumetric 2D video generation device 22.

The background video generation device 53 generates the background video (RGB) and the background video (Depth). The background imaging system ID and the frame number are assigned to the background image (RGB) and the background image (Depth).

Furthermore, the virtual viewpoint information generated by the background video generation device 53 includes the position (x, y, z), the orientation (pan, tilt, roll), and the zoom value of the real camera 51, the background imaging system ID, and the frame number. In the example of FIG. 6, the position (x, y, z) of the real camera 51 is (100.0, 1000, 0, 2200, 0), the orientation (pan, tilt, roll) is (−0.1, 10, 0), the zoom value is 50[%], the background imaging system ID is “XXX”, and the frame number is “1000”.

The volumetric video generation device 72 generates the 3D model data of the person ACT2. The 3D model data of the person ACT2 includes, for example, the 3D shape data in the 3D mesh format and the texture data in the multi-texture format.

The volumetric 2D video generation device 22 generates the volumetric 2D video (RGB) and the volumetric 2D video (Depth). The same background imaging system ID and frame number as the background video (RGB) and the background video (Depth) are assigned to the volumetric 2D video (RGB) and the volumetric 2D video (Depth).

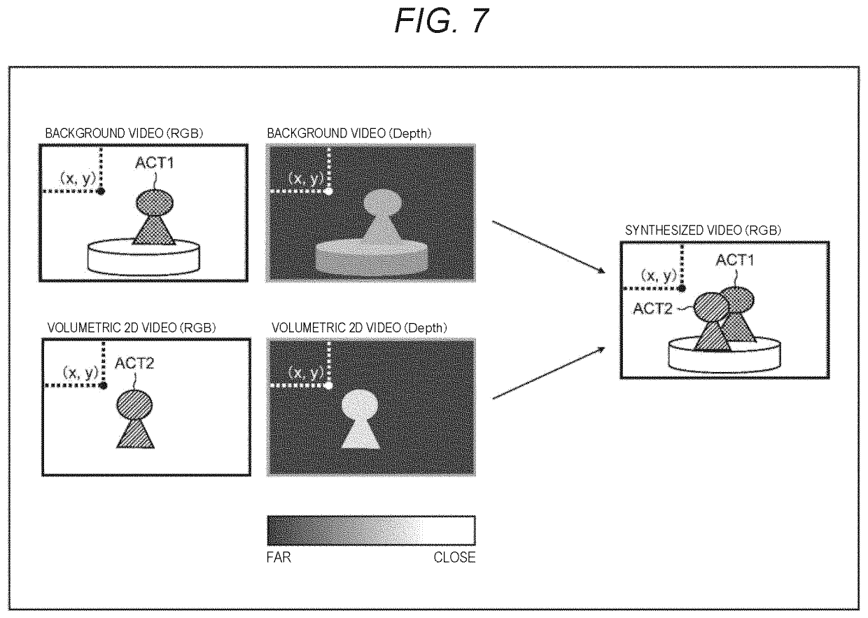

FIG. 7 is a diagram for describing synthesized video generation processing by the video synthesizing device 31.

The video synthesizing device 31 generates the synthesized video (RGB) by synthesizing the background video (RGB) and the background video (Depth) and the volumetric 2D video (RGB) and the volumetric 2D video (Depth), which have the same background imaging system ID and frame number.

The video synthesizing device 31 sets, as a pixel of interest, a predetermined pixel (x, y) of a synthesized video (RGB) to be generated, and compares a depth value of a pixel (x, y) of the background video (Depth) corresponding to the pixel of interest with a depth value of a pixel (x, y) of the volumetric 2D video (Depth).

In the background video (Depth) and the volumetric 2D video (Depth), a magnitude of the depth value is represented by a grey value. A larger grey value (whiter density) indicates a larger depth value and a shorter distance, and a smaller grey value (darker density) indicates a smaller depth value and a longer distance. In the examples of the background video (Depth) and the volumetric 2D video (Depth) of FIG. 7, a depth value indicating that the person ACT2 of the volumetric 2D video (Depth) is closer than the background video (Depth) person ACT1 is stored.

The video synthesizing device 31 generates the synthesized video (RGB) to give priority to a closer subject. That is, the video synthesizing device 31 selects an RGB value of the pixel (x, y) of the background video (RGB) or the volumetric 2D video (RGB) corresponding to a large depth value from the depth value of the pixel (x, y) of the background video (Depth) corresponding to the pixel of interest and the depth value of the pixel (x, y) of the volumetric 2D video (Depth), and sets the selected RGB value as the RGB value of the pixels (x, y) of the synthesized video (RGB).

The video synthesizing device 31 generates the synthesized video (RGB) by sequentially setting, as pixels of interest, all pixels constituting the synthesized video (RGB) and repeating the above-described processing of determining RGB values of the pixels of interest.

Referring back to FIG. 4, the video synthesizing device 31 outputs the generated synthesized video (RGB) to the 2D video delivery device 32. The 2D video delivery device 32 delivers the synthesized video (RGB) to the client device 33 of each user. The synthesized video (RGB) is also output and displayed on the monitor 12 of the background imaging studio and the monitor 23 of the volumetric studio.

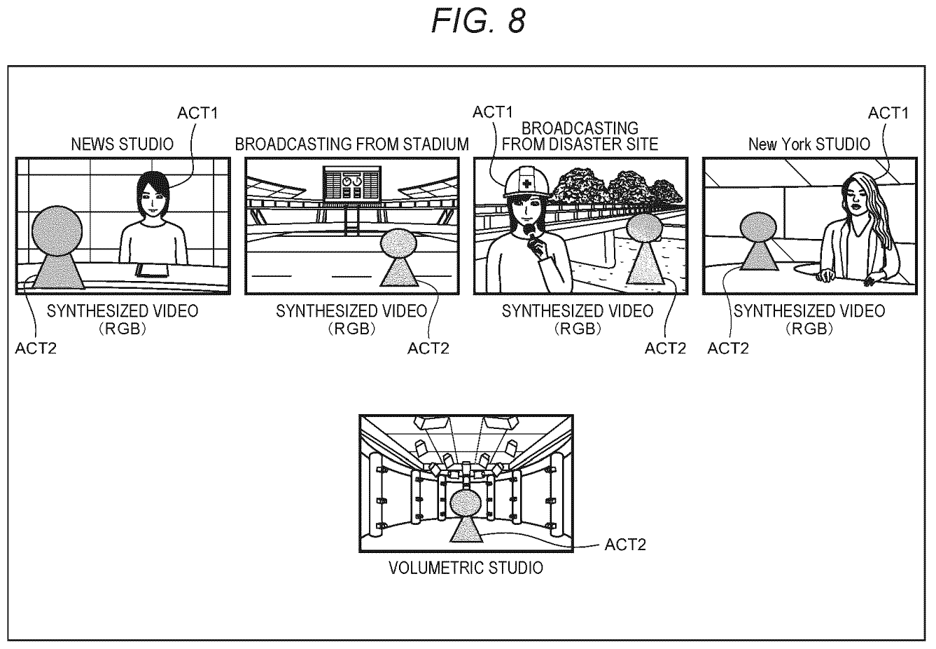

FIG. 8 illustrates an example of a synthesized video (RGB) generated at various places as the background imaging studio.

A first synthesized video (RGB) from the left in an upper part of FIG. 8 illustrates an example in which an indoor news studio is imaged as the background imaging studio and the person ACT2 in the volumetric studio is disposed at a place of the news studio.

A second synthesized video (RGB) from the left in the upper part of FIG. 8 illustrates an example in which an outdoor stadium is imaged as a background imaging studio, and a person ACT2 in a volumetric studio is disposed in a place of the stadium.

The third synthesized video (RGB) from the left (second from the right) in the upper part of FIG. 8 illustrates an example in which a place of an outdoor disaster site is imaged as the background imaging studio and the person ACT2 in the volumetric studio is disposed at a disaster site.

A first synthesized video (RGB) from the right in the upper part of FIG. 8 illustrates an example in which the person ACT2 in the volumetric studio is disposed at a place of a studio in New York (overseas) with a studio in New York as the background imaging studio.

As described above, the person ACT2 in the volumetric studio and the background video imaged by the real camera 51 in the background imaging studio are synthesized, and thus, it is possible to generate a 2D video as if the person ACT2 in the volumetric studio is in front of the real camera 51.

### 4. Volumetric Video Generation Processing

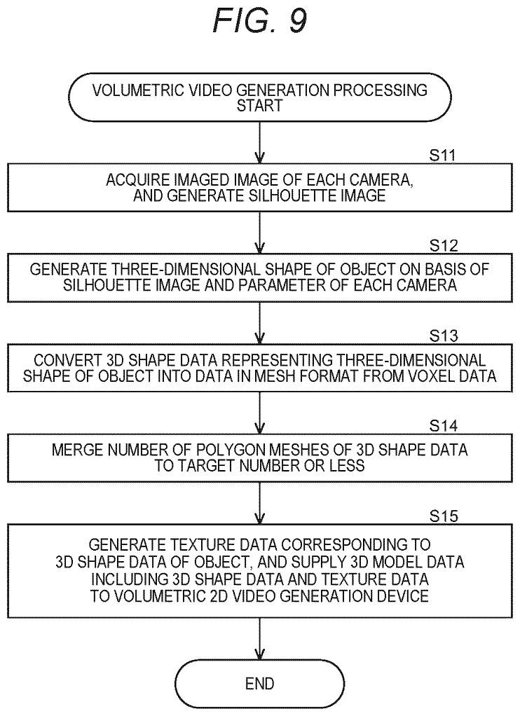

Next, volumetric video generation processing of generating the 3D model data of the person in the volumetric studio performed by the volumetric video generation device 72 will be described with reference to the flowchart of FIG. 9. This processing is started, for example, when imaging by the cameras 71-1 to 71-N is started and an operation to start the generation of the 3D model data is performed in the volumetric video generation device 72.
First, in step S11, the volumetric video generation device 72 acquires the imaged images supplied from the N cameras 71, and generates a silhouette image obtained by representing a region of the person (subject) as a 3D model generation target object by a silhouette, for each of the imaged images of the cameras 71. This processing can be performed by chroma key processing using green of the green back as a key signal.
In step S12, the volumetric video generation device 72 generates (restores) a three-dimensional shape of an object on the basis of the silhouette images of the cameras 71 and the camera parameters. More specifically, the volumetric video generation device 72 projects N silhouette images in accordance with the camera parameters, and generates (restores) the three-dimensional shape of the object by using a visual hull method for cutting out the three-dimensional shape. The three-dimensional shape of the object is represented by voxel data. The camera parameters of the cameras 71 are known by calibration.
In step S13, the volumetric video generation device 72 converts the 3D shape data representing the three-dimensional shape of the object from the voxel data into data in the mesh format called polygon mesh. For example, an algorithm such as a marching cube method can be used for the conversion of the data format of the polygon mesh that is easy to perform rendering processing on the display device.
In step S14, the volumetric video generation device 72 performs mesh reduction for merging the number of polygon meshes of the 3D shape data to a target number or less.
In step S15, the volumetric video generation device 72 generates the texture data corresponding to the 3D shape data of the object, and supplies the 3D model data including the 3D shape data of the object and the texture data to the volumetric 2D video generation device 22. In a case where the multi-texture format described with reference to FIG. 2 is adopted as the texture data, the imaged image imaged by each camera 71 is used as the texture data as it is. Meanwhile, in a case where the UV mapping format described with reference to FIG. 2 is adopted, the UV mapping image corresponding to the shape data of the object is generated as the texture data.

The generated 3D model data of the person in the volumetric studio is supplied from the volumetric video generation device 72 to the volumetric 2D video generation device 22, and the volumetric video generation processing in FIG. 9 is ended. Note that, the volumetric video generation processing in FIG. 9 is repeatedly executed on the imaged images sequentially supplied as the moving images from the cameras 71.

### 5. Volumetric 2D Video Generation Processing

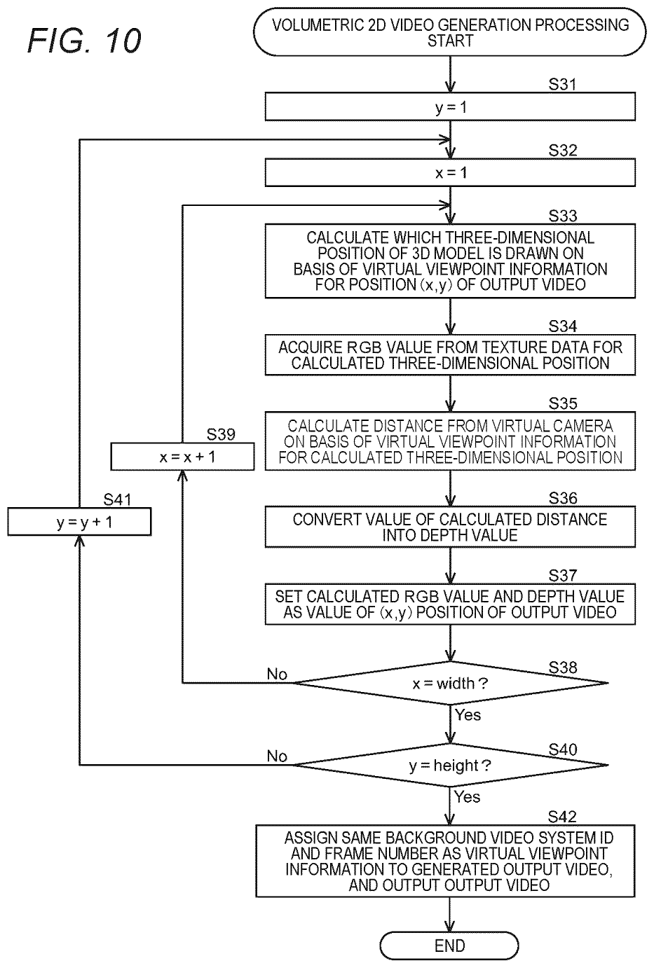

Next, volumetric 2D video generation processing of generating the volumetric 2D video (RGB-D) corresponding to the motion of the real camera 51 performed by the volumetric 2D video generation device 22 will be described with reference to the flowchart of FIG. 10. This processing is started, for example, in a case where the 3D model data of the person is supplied from the volumetric video generation device 72 and the virtual viewpoint information is supplied from the background video generation device 53.

First, in step S31, the volumetric 2D video generation device 22 sets 1 to a y coordinate for determining a pixel of interest (x, y) of the volumetric 2D video (RGB) and the volumetric 2D video (Depth) which are output videos, and in step S32, sets 1 to an x coordinate.
In step S33, the volumetric 2D video generation device 22 calculates which three-dimensional position of the 3D model of the person in the volumetric studio is drawn on the basis of the virtual viewpoint information from the background video generation device 53 for the position (x, y) of the output video.
In step S34, the volumetric 2D video generation device 22 acquires RGB values from the texture data of the 3D model data for the calculated three-dimensional position of the 3D model of the person.
In step S35, the volumetric 2D video generation device 22 calculates a distance from the virtual camera for the calculated three-dimensional position of the 3D model of the person on the basis of the virtual viewpoint information.
In step S36, the volumetric 2D video generation device 22 converts a value of the calculated distance from the virtual camera into a depth value. The conversion from the value of the distance to the depth value may be performed by any method, and for example, the following method can be used. For example, in a case where an imaging area of the volumetric studio is 10 m×10 m×3 m and the depth value of the volumetric 2D video (Depth) is represented by 16 bits, since a maximum value of a distance d in the volumetric studio is 12.65 . . . m, 13.0 m is set as the maximum value of the distance, and the distance d is converted into the depth value depth by the depth value depth=(65535−d*65535/13.0). However, in a case where there is no three-dimensional position of the 3D model matching the pixel of interest (x, y), the depth value depth=0. This depth value increases as the distance decreases.
In step S37, the volumetric 2D video generation device 22 sets the calculated RGB value and depth value as values of (x, y) positions of the volumetric 2D video (RGB) and the volumetric 2D video (Depth) which are the output videos. The RGB value acquired from the texture data is set to the value of the (x, y) position of the volumetric 2D video (RGB), and the depth value converted from the distance value is set to the value of the pixel of interest (x, y) of the volumetric 2D video (Depth).
In step S38, the volumetric 2D video generation device 22 determines whether or not a value of an x coordinate of a current pixel of interest (x, y) is the same as a width width of a video size of the output video.

In a case where it is determined in step S38 that the value of the x coordinate of the current pixel of interest (x, y) is not the same as the width width of the video size of the output video, the processing proceeds to step S39, and the value of the x coordinate is incremented by 1. Thereafter, the processing returns to step S33, and the processing of steps S33 to S38 described above is repeated. That is, processing of calculating the values of the (x, y) positions of the volumetric 2D video (RGB) and the volumetric 2D video (Depth) is performed with another pixel in the same row of the output video as the pixel of interest (x, y).

Meanwhile, in a case where it is determined in step S38 that the value of the x coordinate of the current pixel of interest (x, y) is the same as the width width of the video size of the output video, the processing proceeds to step S40, and the volumetric 2D video generation device 22 determines whether or not a value of a y coordinate of the current pixel of interest (x, y) is the same as a height height of the video size of the output video.

In a case where it is determined in step S40 that the value of the y coordinate of the current pixel of interest (x, y) is not the same as the height height of the video size of the output video, the processing proceeds to step S41, and the value of the y coordinate is incremented by 1. Thereafter, the processing returns to step S32, and the processing of steps S32 to S40 described above is repeated. That is, the processing of steps S32 to S40 described above is repeated until all the rows of the output video are set as the pixel of interest (x, y).

In a case where it is determined in step S40 that the value of the y coordinate of the current pixel of interest (x, y) is the same as the height height of the video size of the output video, the processing proceeds to step S42. In step S42, the volumetric 2D video generation device 22 assigns the same background imaging system ID and frame number as the virtual viewpoint information to the volumetric 2D video (RGB) and the volumetric 2D video (Depth), which are the generated output videos, and outputs the volumetric 2D video (RGB) and the volumetric 2D video (Depth) to the video synthesizing device 31.

As described above, the volumetric 2D video generation processing of FIG. 10 is ended. Note that, this volumetric 2D video generation processing is also repeatedly executed on the basis of the virtual viewpoint information sequentially supplied from the background video generation device 53.

### 6. Synthetic Video Generation Processing

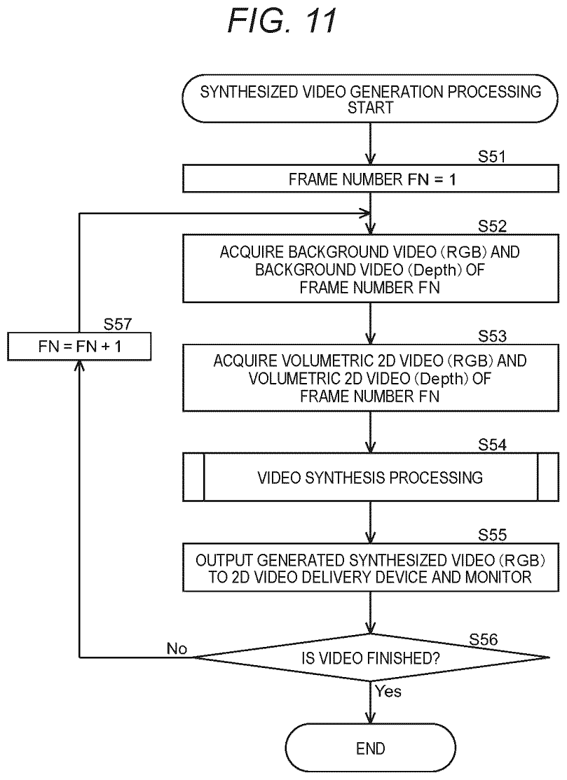

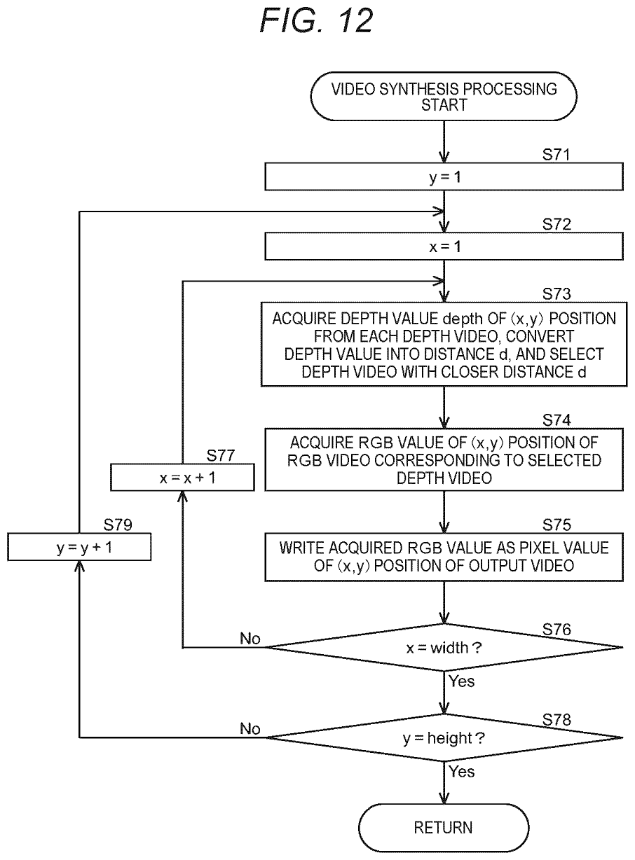

Next, synthesized video generation processing performed by the video synthesizing device 31 will be described with reference to the flowchart of FIG. 11. This processing is started, for example, in a case where the background video (RGB-D) is supplied from the background video generation device 53 and the volumetric 2D video (RGB-D) is supplied from the volumetric 2D video generation device 22.
First, in step S51, the video synthesizing device 31 sets 1 to a variable FN for identifying the frame number.
In step S52, the video synthesizing device 31 acquires the background video (RGB) and the background video (Depth) of the frame number FN from the background video generation device 53.
In step S53, the video synthesizing device 31 acquires the volumetric 2D video (RGB) and the volumetric 2D video (Depth) of the frame number FN from the volumetric 2D video generation device 22.
In step S54, the video synthesizing device 31 executes video synthesis processing of generating the synthesized video (RGB) to give priority to a closer subject. Details of the video synthesis processing will be described later with reference to the flowchart of FIG. 12.
In step S55, the video synthesizing device 31 supplies the generated synthesized video (RGB) to the 2D video delivery device 32, and also supplies the synthesized video to the monitor 12 of the background imaging studio and the monitor 23 of the volumetric studio.
In step S56, the video synthesizing device 31 determines whether or not the video input from the video synthesizing device 31 or the volumetric 2D video generation device 22 is finished.

In a case where it is determined in step S56 that the video is not finished yet, the processing proceeds to step S57, and a value of the frame number FN is incremented by 1. Thereafter, the processing returns to step S52, and the processing of steps S52 to S56 described above is repeated.

Meanwhile, in a case where it is determined in step S56 that the video is not supplied from any one of the video synthesizing device 31 and the volumetric 2D video generation device 22 and the video is finished, the synthesized video generation processing of FIG. 11 is ended.

FIG. 12 is a flowchart illustrating details of the video synthesis processing executed as step S54 of FIG. 11.
First, in step S71, the video synthesizing device 31 sets 1 to a y coordinate for determining a pixel of interest (x, y) of the synthesized video (RGB) which is the output video, and sets 1 to an x coordinate in step S72.
In step S73, the video synthesizing device 31 acquires a depth value depth of the (x, y) position from each video of the background video (Depth) and the volumetric 2D video (Depth), converts the depth value depth into the distance d, and selects the depth video with a closer distance d.
In step S74, the video synthesizing device 31 acquires an RGB value at the (x, y) position of the RGB video corresponding to the selected depth video. That is, the video synthesizing device 31 acquires the RGB value at the (x, y) position of the background video (RGB) in a case where the selected depth video is the background video (Depth), and acquires the RGB value at the (x, y) position of the volumetric 2D video (RGB) in a case where the selected depth video is the volumetric 2D video (Depth).
In step S75, the video synthesizing device 31 writes the acquired RGB value as the pixel value at the (x, y) position of the synthesized video (RGB) which is the output video.
In step S76, the video synthesizing device 31 determines whether or not the value of the x coordinate of the current pixel of interest (x, y) is the same as the width width of the video size of the output video.

In a case where it is determined in step S76 that the value of the x coordinate of the current pixel of interest (x, y) is not the same as the width width of the video size of the output video, the processing proceeds to step S77, and the value of the x coordinate is incremented by 1. Thereafter, the processing returns to step S73, and the processing of steps S73 to S76 described above is repeated. That is, processing of acquiring and writing an RGB value closer to the distance d is performed with another pixel in the same row of the output video as the pixel of interest (x, y).

Meanwhile, in a case where it is determined in step S76 that the value of the x coordinate of the current pixel of interest (x, y) is the same as the width width of the video size of the output video, the processing proceeds to step S78, and the video synthesizing device 31 determines whether or not the value of the y coordinate of the current pixel of interest (x, y) is the same as the height height of the video size of the output video.

In a case where it is determined in step S78 that the value of the y coordinate of the current pixel of interest (x, y) is not the same as the height height of the video size of the output video, the processing proceeds to step S79, and the value of the y coordinate is incremented by 1. Thereafter, the processing returns to step S72, and the processing of steps S72 to S78 described above is repeated. That is, the processing of steps S72 to S78 described above is repeated until all the rows of the output video are set as the pixel of interest (x, y).

In a case where it is determined in step S78 that the value of the y coordinate of the current pixel of interest (x, y) is the same as the height height of the video size of the output video, the video synthesis processing executed in step S54 of FIG. 11 is ended, and the processing proceeds to step S55 of FIG. 11.

As described above, according to the image processing system 1 of the first embodiment, it is possible to generate, in real time, the synthesized video obtained by synthesizing the video of the subject (for example, person) imaged by the N cameras 71 in the volumetric studio and the background video imaged by the real camera 51 in the background imaging studio, and it is possible to output the synthesized video to the 2D video delivery device 32.

### 7. Comparison With Other Systems

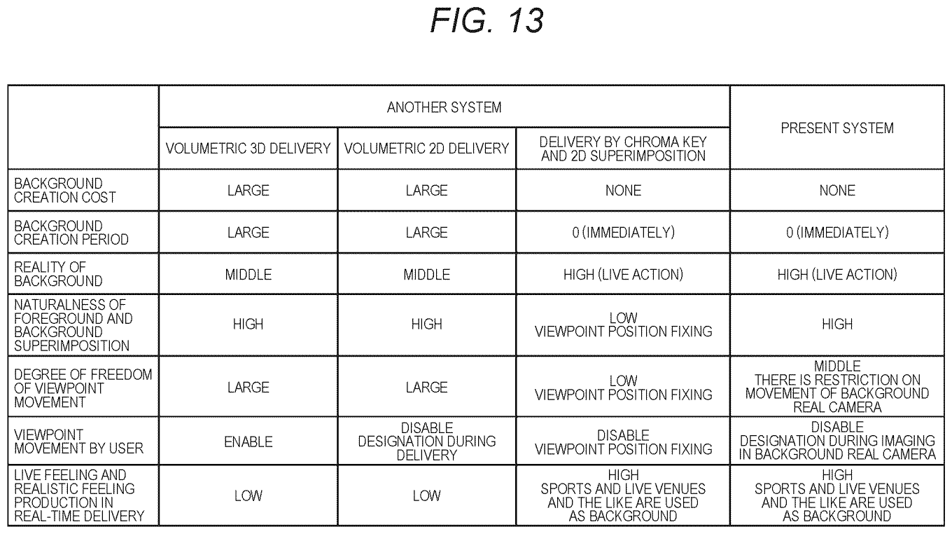

FIG. 13 is a table comparing the image processing system 1 (hereinafter, referred to as the present system.) of the first embodiment described above with another system. Features of the present system compared with another system will be described with reference to FIG. 13.

From the viewpoint of comparing the systems, background creation cost, a background creation period, reality of the background, naturalness of foreground and background superimposition, a degree of freedom of viewpoint movement, the viewpoint movement by the user, and live feeling and realistic feeling production in real-time delivery were examined. Furthermore, “volumetric 3D delivery”, “volumetric 2D delivery”, and “delivery by chroma key and 2D superimposition” were considered as another system to be compared with the present system. The “volumetric 3D delivery” is a method for creating the background in the volumetric technique in a system in which a virtual viewpoint of the 3D model is determined on a user side of a delivery destination and the delivery is performed such that each user can freely change the viewpoint. The “volumetric 2D delivery” is a method for creating the background in the volumetric technique in a system in which a virtual viewpoint is determined on a delivery side and videos of the same virtual viewpoint are delivered to a plurality of users. The “delivery by chroma key and 2D superimposition” is a system that superimposes a 2D video of the background on a foreground subject video imaged by a chroma key studio and delivers the superimposed video.

Regarding the background creation cost (cost for creating the background video) and the background creation period (period for creating the background video, since the cost and the period become large, the “volumetric 3D delivery” and the “Volumetric 2D delivery” using the volumetric technique are disadvantageous. On the other hand, since the “delivery by chroma key and 2D superimposition” and the present system immediately uses the video actually imaged by the camera, it does not take cost and time.

Regarding the reality of the background (the reality of the background video), the “volumetric 3D delivery” and “volumetric 2D delivery” depend on quality of a 3D CG image of the background. According to the “delivery by chroma key and 2D superimposition” and the present system, since the background video is a live-action video actually imaged by the camera, high realism can be expressed.

Regarding the naturalness of the foreground and background superimposition, the “volumetric 3D delivery”, the “Volumetric 2D delivery”, and the present system using the virtual camera (virtual viewpoint information) can express the naturalness of the superimposition. On the other hand, in the “delivery by chroma key and 2D superimposition”, it is not possible to cause the camera on the foreground side and the camera on the background side to accurately coincide with each other, and a method for synthesizing the background video while fixing a viewpoint position is generally performed. Therefore, in the “delivery by chroma key and 2D superimposition”, since a sense of synthesizing cannot be removed and a natural video cannot be generated, the naturalness of the superimposition is lowered.

Regarding the degree of freedom of the viewpoint movement, the “volumetric 3D delivery” and the “volumetric 2D delivery” using the virtual camera (virtual viewpoint information) are advantageous. This system can also move, but since the real camera 51 is used, there is a certain restriction on the movement. Since the “delivery by chroma key and 2D superimposition” has a fixed viewpoint position, the degree of freedom is low.

Regarding the viewpoint movement by the user, only the “volumetric 3D delivery” can be realized, and regarding the “volumetric 2D delivery”, the “delivery by chroma key and 2D superimposition”, and the present system, the user cannot determine the viewpoint.

Regarding the live feeling and realistic feeling production in the real-time delivery, it is difficult to produce the live feeling and realistic feeling in the “volumetric 3D delivery” and the “volumetric 2D delivery” using the 3D CG image as the background. The “delivery by chroma key and 2D superimposition” and the present system can use a sports venue or a live venue as the background video, and can produce a high live feeling and realistic feeling.

As described above, in the present system, in the comparison with the “volumetric 3D delivery” and the “volumetric 2D delivery”, since a realistic video actually imaged can be used as the background video at low cost without a creation period and real-time delivery can be performed, it is possible to give a live feeling and a realistic feeling on a site to the user.

Furthermore, in comparison with the “delivery by chroma key and 2D superimposition”, since the present system uses information of the real camera 51 as the virtual camera (virtual viewpoint information), the naturalness of the foreground and background superimposition is remarkably high. That is, the performer of the volumetric studio can appear in the background video (live-action video) in a form indistinguishable from the real performer being at the place.

As described above, according to the present system, 2D delivery capable of producing a realistic feeling can be realized at low cost.

### 8. Variation of First Embodiment

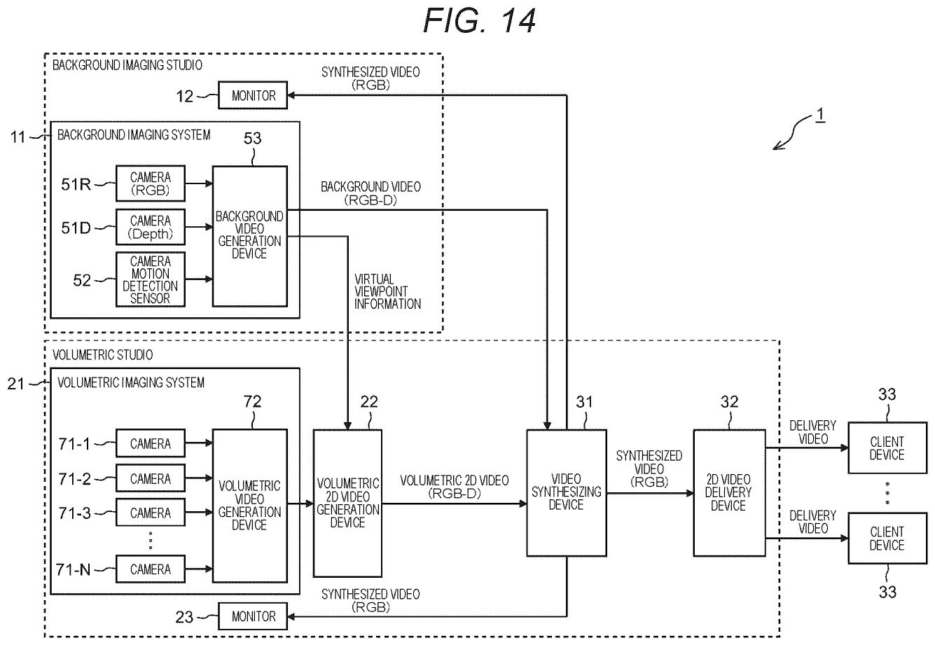

FIG. 14 is a block diagram illustrating a variation of the first embodiment of the image processing system described above.

In the first embodiment described above, the background imaging system 11 is installed in a background imaging studio, the volumetric imaging system 21 and the volumetric 2D video generation device 22 are installed in the volumetric studio, the video synthesizing device 31 is installed in the video synthesizing center, and the 2D video delivery device 32 is installed in the delivery center.

However, the background imaging system 11, the volumetric imaging system 21, the volumetric 2D video generation device 22, the video synthesizing device 31, and the 2D video delivery device 32 may not be independently installed at different places, and two or more devices or systems may be installed at the same place.

For example, as illustrated in FIG. 14, the video synthesizing device 31 and the 2D video delivery device 32 may be disposed in the volumetric studio in which the volumetric imaging system 21 and the volumetric 2D video generation device 22 are installed.

On the contrary, although not illustrated, the video synthesizing device 31 and the 2D video delivery device 32 may be disposed in the background imaging studio in which the background imaging system 11 is installed.

Alternatively, the video synthesizing device 31 and the 2D video delivery device 32 may be disposed in the same center (for example, delivery center), and may be disposed at three places of the background imaging studio, the volumetric studio, and the delivery center.

### 9. Second Embodiment of Image Processing System

Next, a second embodiment of the image processing system to which the present technology is applied will be described. The second embodiment is a mode in which a plurality of background imaging systems 11 or a plurality of volumetric imaging systems 21 is provided.

In the drawings of the second embodiment to be described later, parts corresponding to the first embodiment illustrated in FIG. 3 are denoted by the same reference signs, and description of the parts will be omitted as appropriate, focusing on description of different parts.

### First Configuration Example of Second Embodiment

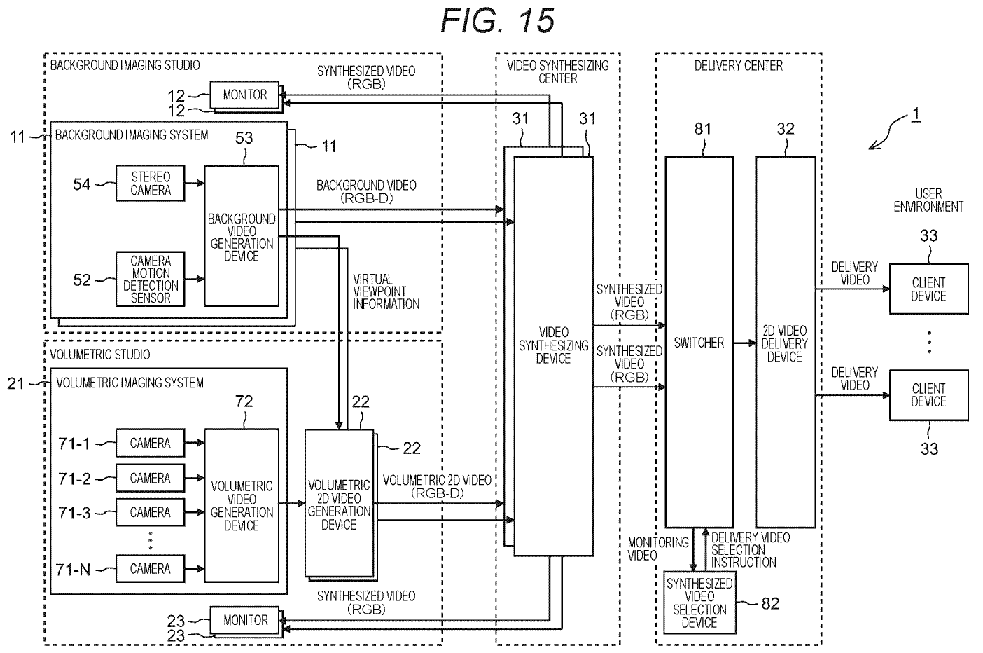

FIG. 15 is a block diagram illustrating a first configuration example of an image processing system according to the second embodiment.

The first configuration example of the second embodiment is a configuration in which the plurality of background imaging systems 11 is provided in one background imaging studio.

In FIG. 15, two background imaging systems 11 are provided in one background imaging studio. Furthermore, two monitors 12 are provided to correspond to the two background imaging systems 11. Note that, the example of FIG. 15 is an example of a case where the two background imaging systems 11 are provided, but three or more background imaging systems 11 may be provided as a matter of course.

Furthermore, in the first embodiment described above, although the camera of the background imaging studio includes the RGB camera 51R and the depth camera 51D, in the second embodiment, the camera includes a stereo camera 54. Since the camera of the background imaging system 11 can be only required to acquire the RGB value (2D video) and the depth value (depth video) of the subject, the camera may be the stereo camera 54 instead of the combination of the RGB camera 51R and the depth camera 51D. The stereo camera 54 generates the RGB value (2D video) and the depth value (depth video) of the subject by performing stereo matching processing on the basis of two RGB videos obtained by imaging the subject.

Furthermore, in the first configuration example of the second embodiment, even though the plurality of background imaging systems 11 is provided, the same number (two) of the volumetric 2D video generation devices 22 and the monitors 23 of the volumetric studio and the video synthesizing devices 31 of the video synthesizing center are provided as the background imaging systems 11.

In other words, in the first configuration example of the second embodiment, the monitor 12 of the background imaging studio, the volumetric 2D video generation device 22 and the monitor 23 of the volumetric studio, and the video synthesizing device 31 of the video synthesizing center are provided to correspond to one background imaging system 11. The synthesized video (RGB) corresponding to the background video (RGB-D) imaged by the stereo camera 54 is generated by the set of the volumetric 2D video generation device 22 and the video synthesizing device 31 corresponding to the background imaging system 11.

Moreover, in the delivery center, a switcher (selection unit) 81 and a synthesized video selection device 82 are added to a preceding stage of the 2D video delivery device 32. The switcher 81 generates a monitoring video in which the synthesized videos (RGB) supplied from the two video synthesizing devices 31 are integrated into one screen, and supplies the monitoring video to the synthesized video selection device 82. Furthermore, the switcher 81 selects one of the synthesized videos (RGB) supplied from the two video synthesizing devices 31 on the basis of a delivery video selection instruction supplied from the synthesized video selection device 82, and supplies the selected synthesized video to the 2D video delivery device 32.

The synthesized video selection device 82 displays the monitoring video supplied from the switcher 81 on an external display. The synthesized video selection device 82 generates the delivery video selection instruction for selecting one of the two synthesized videos (RGB) included in the monitoring video on the basis of a selection operation of the user (operator) for confirming the monitoring video displayed on the external display, and supplies the delivery video selection instruction to the switcher 81. The user (operator) who operates the synthesized video selection device 82 confirms the monitoring video, and performs a button operation of selecting, as the delivery video, one of the two synthesized videos (RGB) included in the monitoring video. Furthermore, the synthesized video selection device 82 may be able to designate, as the monitoring video, how to integrate the two synthesized videos (RGB) into one screen.

The first configuration example of the second embodiment has the above configuration.

Note that, in the second exemplary embodiment, although the switcher 81 selects one of the synthesized videos (RGB) supplied from the two video synthesizing devices 31 and supplies the selected synthesized video to the 2D video delivery device 32, the synthesized videos (RGB) supplied from the two video synthesizing devices 31 may be arrayed horizontally, or the synthesized videos integrated into one screen by setting screen sizes to be different by PinP (Picture in Picture) or the like may be generated, and may be supplied, as the delivered video, to the 2D video delivery device 32. In this case, the synthesized video selection device 82 may be omitted.

In a case where three or more background imaging systems 11 are provided in the background imaging studio, the same number of volumetric 2D video generation devices 22 of the volumetric studio and video synthesizing devices 31 of the video synthesizing center as the background imaging systems 11 are provided. The switcher 81 selects one of the plurality of synthesized images (RGB) and supplies the selected synthesized image to the 2D video delivery device 32.

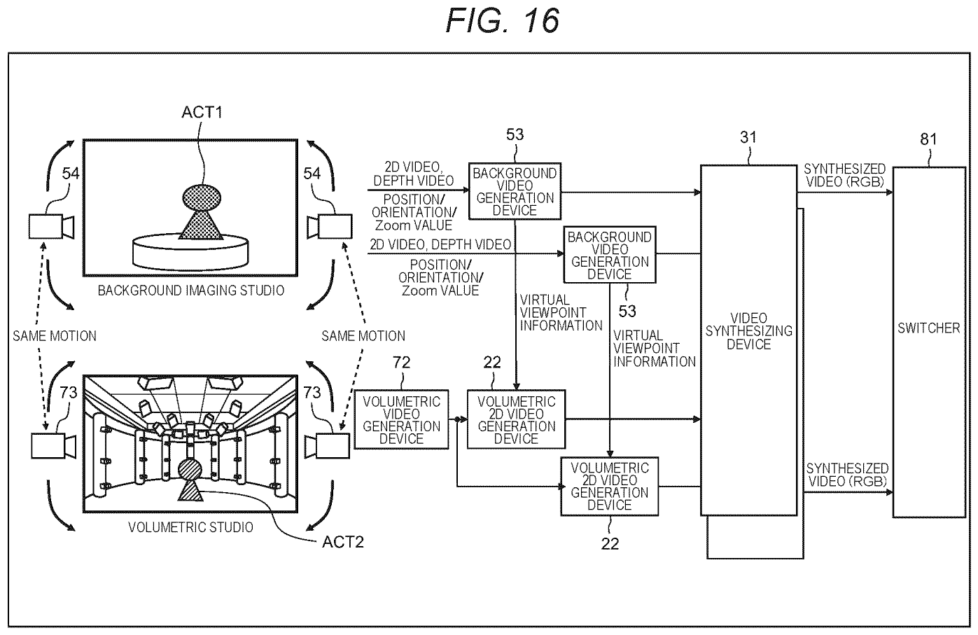

An operation of the first configuration example in the second embodiment will be described with reference to FIG. 16.

In the background imaging studio, two stereo cameras 54 image the person ACT1 who is the subject at different camera positions and orientations. Each of the two stereo cameras 54 outputs the 2D video and the depth video obtained by imaging the subject to the corresponding background video generation device 53. Similarly to the first embodiment, the camera motion detection sensor 52 also acquires the position, orientation, and zoom value of the corresponding stereo camera 54, and outputs the acquired position, orientation, and zoom value to the corresponding background video generation device 53.

Each of the two background video generation devices 53 sets, as the background video (RGB) and the background video (Depth), the 2D video and the depth video having the same angle of view supplied from the corresponding stereo camera 54, assigns the background imaging system ID and the frame number, and outputs the background video to the video synthesizing device 31. Furthermore, the background video generation device 53 assigns the background imaging system ID and the frame number to the position, orientation, and zoom value of the corresponding stereo camera 54, and outputs, as the virtual viewpoint information, the position, orientation, and zoom value to the corresponding volumetric 2D video generation device 22.

Each of the volumetric 2D video generation devices 22 generates the volumetric 2D video (RGB) and the volumetric 2D video (Depth) of the person ACT2 from the same viewpoint as the corresponding stereo camera 54 by using the virtual viewpoint information supplied from the corresponding background video generation device 53, and outputs the generated images to the corresponding video synthesizing device 31. That is, the volumetric 2D video generation device 22 assumes the virtual camera 73 that moves in the same manner as the corresponding stereo camera 54, and generates the volumetric 2D video (RGB) and the volumetric 2D video (Depth) viewed from the virtual camera 73.

Each of the two video synthesizing devices 31 generates the synthesized video (RGB) by synthesizing the background video (RGB) and the background video (Depth) supplied from the corresponding background video generation device 53 and the videos having the same background imaging system ID and frame number of the volumetric 2D video (RGB) and the volumetric 2D video (Depth) supplied from the corresponding volumetric 2D video generation device 22.

The switcher 81 selects one of the two synthesized videos (RGB) and supplies the selected synthesized video to the 2D video delivery device 32. The delivery video delivered to the client device 33 is a video that emulates a situation in which there are two cameras in the studio. That is, the video is the same background video in which two synthesized videos (RGB) having different imaging angles are switched.

### Second Configuration Example of Second Embodiment

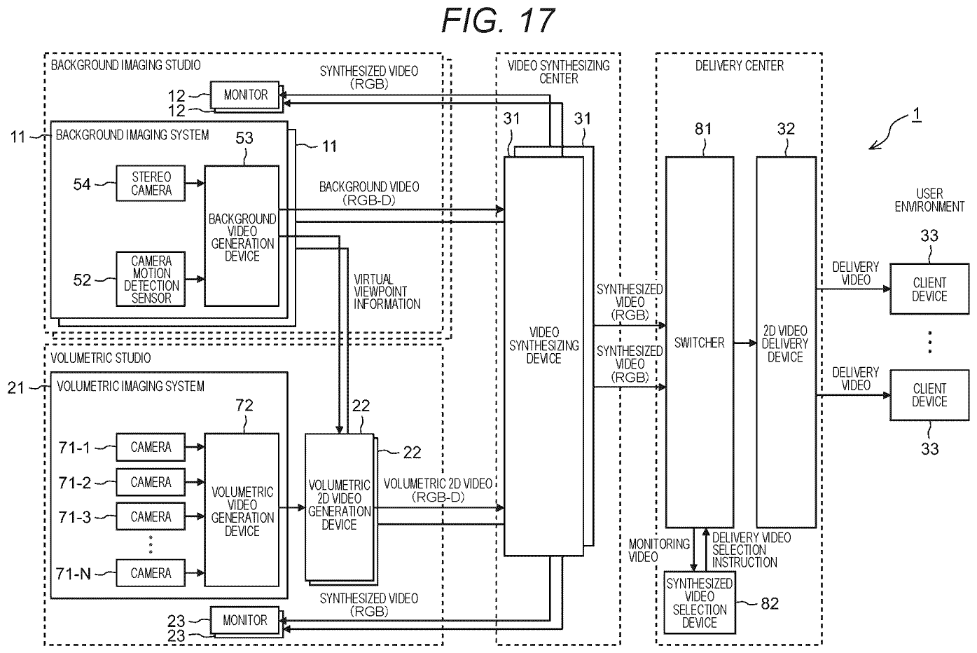

FIG. 17 is a block diagram illustrating a second configuration example of the image processing system according to the second embodiment.

The second configuration example of the second embodiment is a configuration in which two background imaging studios are provided and one background imaging system 11 is provided in each background imaging studio.

In FIG. 17, although the two background imaging systems 11 and two monitors 12 are provided similarly to the first configuration example of FIG. 15, the two background imaging systems and the two monitors are different from each other in that the two background imaging systems and the two monitors are provided one by one in one background imaging studio instead of one background imaging studio.

Therefore, in the first configuration example, although the two synthesized videos (RGB) supplied to the switcher 81 are the same background video (however, the imaging angles are different), the two synthesized videos (RGB) of the second configuration example are different background videos.

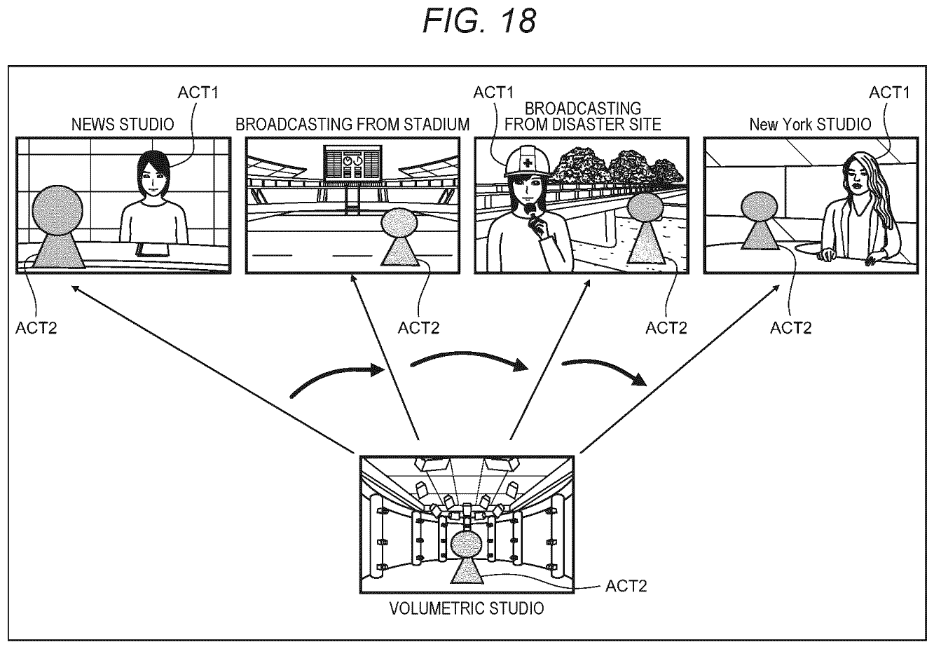

FIG. 18 illustrates an example of a delivery video in a case where four background imaging studios are provided and one background imaging system 11 is provided in each background imaging studio in the second configuration example of the second embodiment.

There are four background imaging locations of an indoor news studio, an outdoor stadium, an outdoor disaster site, and New York (overseas), and the background imaging system 11 is installed in each of the four background imaging locations.

There is one volumetric studio, and the volumetric imaging system 21 images the person ACT2.

In this case, the switcher 81 sequentially selects, as the delivery videos, and switches the four synthesized videos (RGB) supplied from the four video synthesizing devices 31, and thus, it is possible to deliver a scene in which the person ACT2 instantaneously moves and participates at each background imaging place.

### Third Configuration Example of Second Embodiment

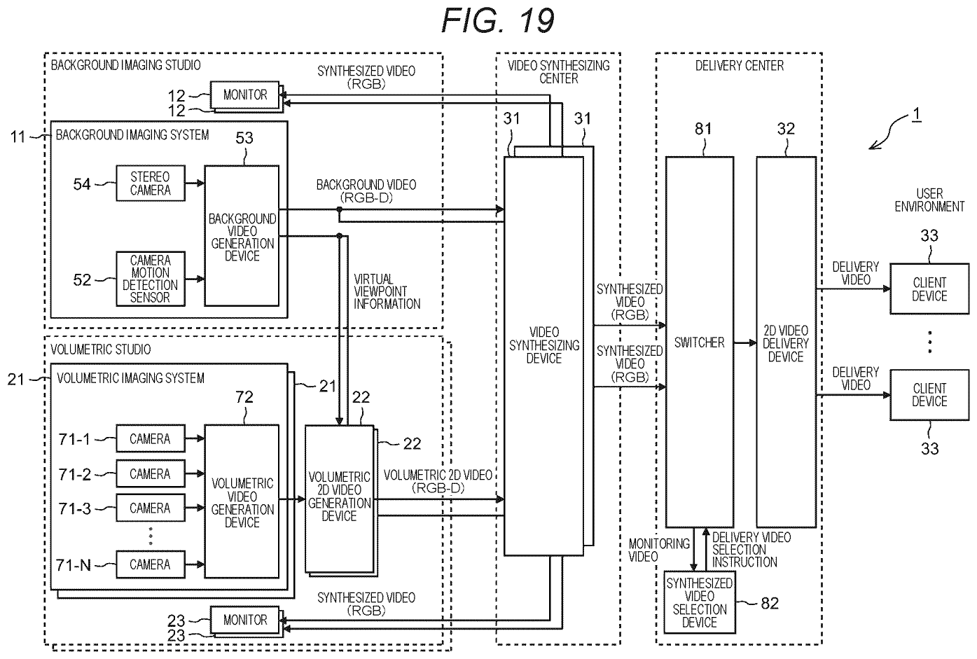

FIG. 19 is a block diagram illustrating a third configuration example of the image processing system according to the second embodiment.

The third configuration example of the second embodiment is a configuration in which two volumetric studios are provided, and one volumetric imaging system 21, one volumetric 2D video generation device 22, and one monitor 23 are provided in each volumetric studio. The two volumetric studios are referred to as a volumetric studio A and a volumetric studio B to be distinguished.

In the video synthesizing center, the same number (two) of video synthesizing devices 31 as the volumetric 2D video generation devices 22 are provided, and the switcher 81 and the synthesized video selection device 82 are added at a preceding stage of the 2D video delivery device 32 in the delivery center.

The background video generation device 53 of the background imaging studio assigns the background imaging system ID and the frame number to the generated background video (RGB-D), and outputs the background video to the plurality of video synthesizing devices 31. Furthermore, the background video generation device 53 generates the virtual viewpoint information and outputs the virtual viewpoint information to the volumetric 2D video generation device 22 of each volumetric studio. In the background imaging studio, two monitors 12 are installed to display the synthesized video (RGB) generated by the two video synthesizing devices 31.

The volumetric imaging system 21 of the volumetric studio A generates the 3D model of the person ACT2 as the subject and outputs the 3D model data to the corresponding volumetric 2D video generation device 22.

The volumetric 2D video generation device 22 of the volumetric studio A generates the volumetric 2D video (RGB-D) of the person ACT2 from the same viewpoint as the stereo camera 54 by using the 3D model data of the person ACT2, assigns the same background imaging system ID and frame number as the virtual viewpoint information, and outputs the generated video to the corresponding video synthesizing device 31 (first video synthesizing device 31).

The volumetric imaging system 21 of the volumetric studio B generates the 3D model of the person ACT3 as the subject and outputs the 3D model data to the corresponding volumetric 2D video generation device 22.

The volumetric 2D video generation device 22 of the volumetric studio B generates the volumetric 2D video (RGB-D) of the person ACT3 of the same viewpoint as the stereo camera 54 by using the 3D model data of the person ACT3, assigns the same background imaging system ID and frame number as the virtual viewpoint information, and outputs the generated video to the corresponding video synthesizing device 31 (second video synthesizing device 31).

The first video synthesizing device 31 acquires the background video (RGB-D) from the background video generation device 53 and the volumetric 2D video (RGB-D) from the volumetric 2D video generation device 22 of the volumetric studio A, and generates the synthesized video (RGB) of the person ACT2.

The second video synthesizing device 31 acquires the background video (RGB-D) from the background video generation device 53 and the volumetric 2D video (RGB-D) from the volumetric 2D video generation device 22 of the volumetric studio B, and generates the synthesized video (RGB) of the person ACT3.

The switcher 81 generates the monitoring video in which two synthesized videos (RGB) supplied from the two video synthesizing devices 31 are integrated into one screen, and supplies the generated monitoring video to the synthesized video selection device 82. Furthermore, the switcher 81 selects one of the synthesized video of the person ACT2 (RGB) or the synthesized video of the person ACT3 (RGB) on the basis of the delivery video selection instruction supplied from the synthesized video selection device 82, and supplies the selected synthesized video to the 2D video delivery device 32.

As described above, in the third configuration example, the image processing system 1 can generate two of the synthesized video (RGB) obtained by synthesizing the person ACT2 in the volumetric studio A and the synthesized video (RGB) obtained by synthesizing the person ACT3 in the volumetric studio B and the same background video (RGB-D), and can select and deliver one of the synthesized videos.

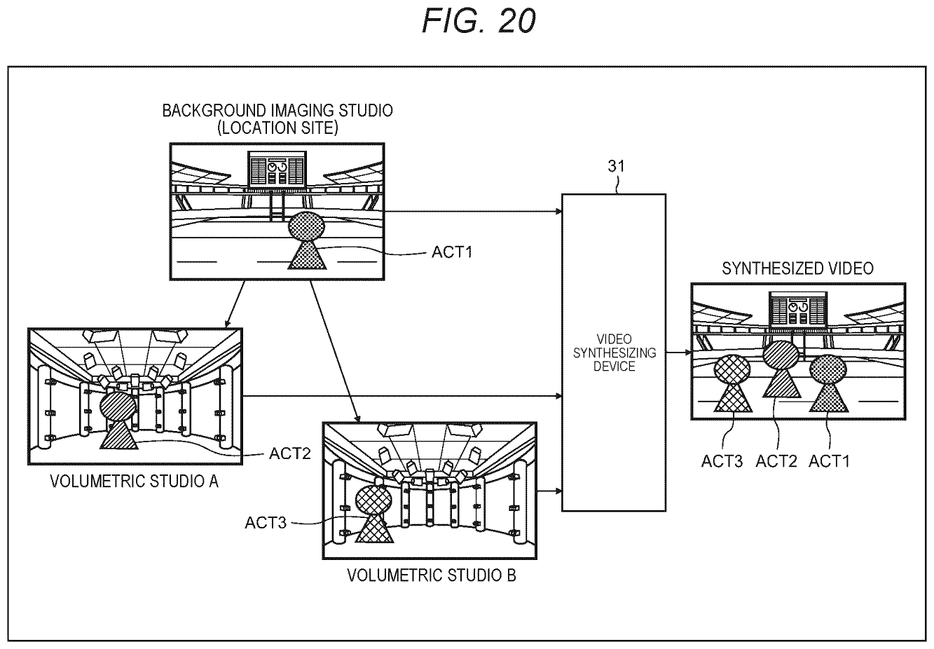

Alternatively, in the third configuration example, as illustrated in FIG. 20, the image processing system 1 can also generate and deliver the synthesized video (RGB) obtained by synthesizing the person ACT2 and the person ACT3 in different volumetric studios into one screen. In this case, the volumetric 2D video (RGB-D) of the person ACT2 and the volumetric 2D video (RGB-D) of the person ACT3 are supplied to one video synthesizing device 31. The video synthesizing device 31 compares the depth values at the same pixel position of the background video (RGB-D), the volumetric 2D video (RGB-D) of the person ACT2, and the volumetric 2D video (RGB-D) of the person ACT3, and generates the synthesized video (RGB).

As described above, the plurality of background imaging systems 11 can be provided in one background imaging studio, the plurality of background imaging systems 11 can be provided in the plurality of background imaging studios, or the plurality of volumetric imaging systems 21 can be provided in the plurality of volumetric studio.

Note that, although not illustrated, the plurality of background imaging studios and the plurality of volumetric studios may also be provided.

In the second embodiment, although the stereo camera 54 is used instead of the RGB camera 51R and the depth camera 51D, it goes without saying that the RGB camera 51R and the depth camera 51D may be used similarly to the first embodiment. Furthermore, in the first embodiment and other embodiments as described later, the RGB camera 51R and the depth camera 51D and the stereo camera 54 may be replaced with each other.

### 10. Third Embodiment of Image Processing System

Next, a third embodiment of the image processing system will be described.

In the third embodiment, a case where the place of the background imaging system 11 is in an outdoor imaging environment called a location site instead of a studio (background imaging studio) in a general building is assumed. For example, the background imaging system 11 performs imaging while moving in a travel program, broadcasting from a marathon roadside, broadcasting such as mountain climbing, or any location (place) such as a town. In such a case, unlike the studio in the building, since an imaging range moves, the image processing system 1 has a configuration in which the position of the origin can be moved with the movement of the real camera 51.

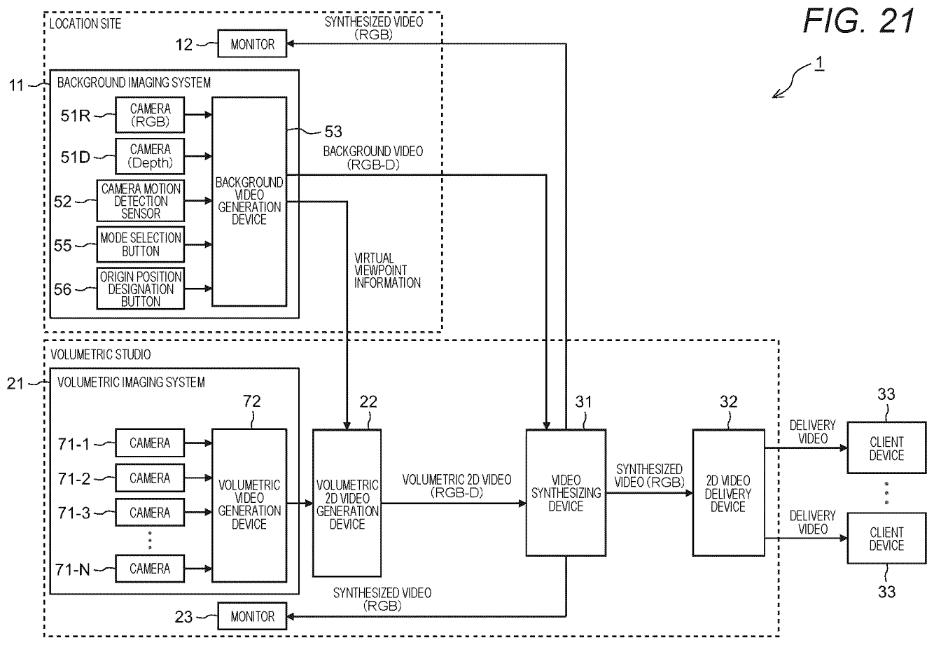

FIG. 21 is a block diagram illustrating the third embodiment of the image processing system to which the present technology is applied.

In the drawings of the third embodiment, parts corresponding to the first embodiment illustrated in FIG. 3 are denoted by the same reference signs, and description of the parts will be omitted as appropriate, focusing on description of different parts.

In the third embodiment, the background imaging system 11 is disposed at a location site (location place). The background imaging system 11 includes a mode selection button 55 and an origin position designation button 56 in addition to the camera 51R, the camera 51D, the camera motion detection sensor 52, and the background video generation device 53, which are similar to the first embodiment. In the third embodiment, the camera 51R and the camera 51D (real camera 51) are, for example, small cameras that are easy to move and image. The mode selection button 55 and the origin position designation button 56 may be provided as operation buttons of the camera 51R and the camera 51D.

The camera motion detection sensor 52 includes a sensor suitable for the real camera 51 to be moved, such as a global positioning system (GPS), a gyro sensor, or an acceleration sensor.

The mode selection button 55 is a button for a camera operator to control whether or not the origin position is moved. The camera operator can switch between three coordinate setting modes of a link mode, a lock mode, and a correction mode by operating the mode selection button 55.

The link mode is a mode in which the origin position moves in conjunction with the movement of the real camera 51. In the link mode, when the real camera 51 moves, the origin position on the location site (background imaging studio) moves as it is, but a virtual viewpoint position indicated as relative coordinates from the origin does not move.

In the lock mode, the origin position is locked to a current setting position. The lock mode operates similarly to the first embodiment (fixed camera) after the origin position is fixed at a predetermined place. That is, a difference in movement of the real camera 51 is handled as a movement amount of the virtual camera as it is. The imaging range is fixed, and the virtual viewpoint moves in accordance with the movement of the camera operator.

The correction mode is basically the same as the operation of the link mode, but the camera operator can freely correct (move) the origin position. For example, in a case where a height of a floor surface is different between the origin position and a position of the camera operator, in the link mode, the position of the performer displayed in the synthesized video (RGB) may float or may get stuck on the floor surface. Such a shift can be corrected by the camera operator correcting the origin position in the correction mode.

The origin position designation button 56 is a button for designating a corrected origin position in a case where the origin position is corrected in the correction mode. Any designation method may be used as long as a correction value (movement amount) of each of the x coordinate, the y coordinate, and the z coordinate can be designated. Furthermore, not only the origin position but also the orientation of the real camera 51 may be corrected.

In the third embodiment, the video synthesizing device 31 and the 2D video delivery device 32 are disposed in the volumetric studio similarly to the modification of the first embodiment illustrated in FIG. 14.

Other configurations of the third embodiment are similar to the first embodiment described above. The image processing system 1 of the third embodiment has the above configuration.

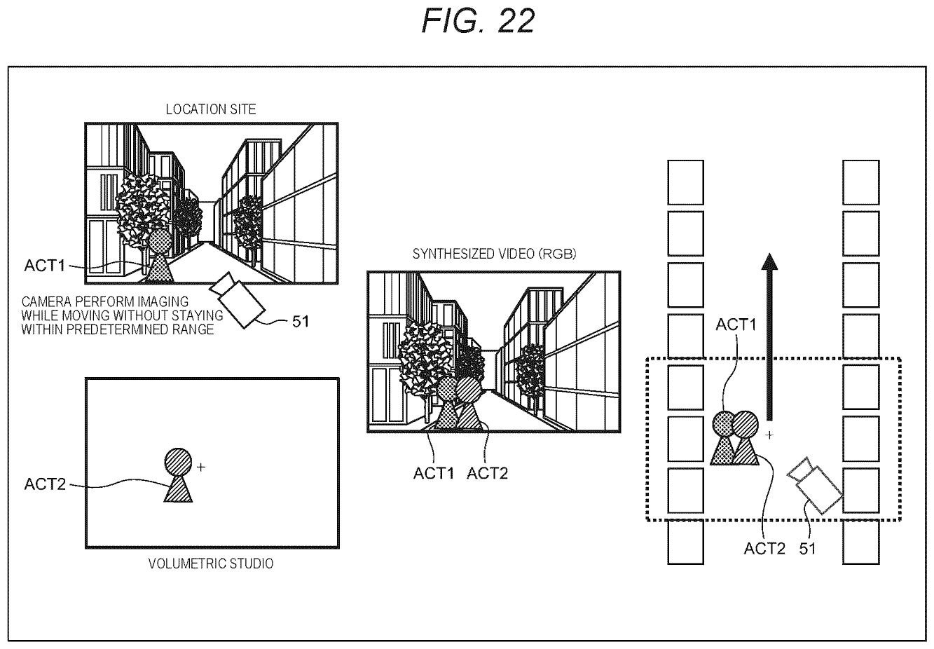

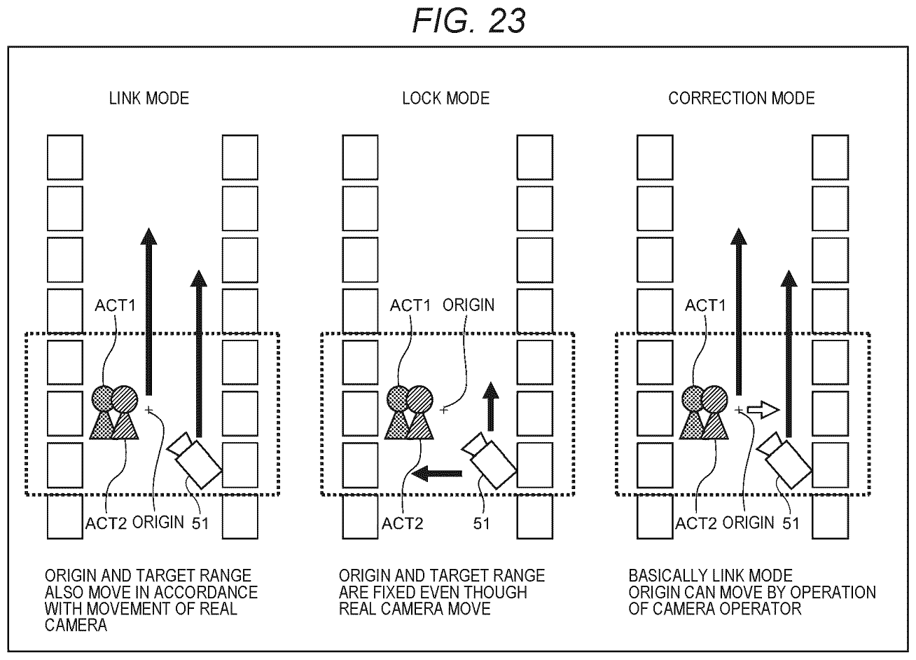

An origin operation in each coordinate setting mode of the link mode, the lock mode, and the correction mode will be described with reference to FIGS. 22 and 23.

FIG. 22 is an image diagram illustrating a scene of imaging by the background imaging system 11 and the volumetric imaging system 21 according to the third embodiment.

The location site is a passage in which buildings are arranged on the left and right. The real camera 51 images the person ACT1 standing on the passage. Meanwhile, the person ACT2 is present as the performer in the volumetric studio, and the volumetric imaging system 21 is imaging the person ACT2.

The synthesized video (RGB) obtained by synthesizing the background video (RGB-D) obtained by imaging the person ACT1 at the location site and the volumetric 2D video (RGB-D) obtained by imaging the person ACT2 in the volumetric studio is a video as if both the person ACT1 and the person ACT2 exist in the passage at the location site.

A plan view on a right side of FIG. 22 illustrates a positional relationship between the passage and the person ACT1 and a moving direction of the person ACT1. The person ACT1 moves in a depth direction in the passage, and the real camera 51 performs imaging while moving in accordance with the movement of the person ACT1.

FIG. 23 illustrates origin processing in each coordinate setting mode of the link mode, the lock mode, and the correction mode.

In the link mode, when the real camera 51 moves with the movement of the person ACT1, an origin position and an imaging target range of the location site also move. The virtual viewpoint position shown as relative coordinates from the origin does not move. The synthesized video (RGB) is a video in which the person ACT1 and the person ACT2 are at the same position in the screen and the building in the background moves with the movement of the person.

In the lock mode, even though the real camera 51 moves, the origin position and the imaging target range do not move. The movement of the real camera 51 is handled as the movement of the virtual camera as it is. In a case where it is desired to fix the imaging target range, for example, the imaging target range is suitable for imaging while the person ACTI stops.

The correction mode basically operates similarly to the link mode. The camera operator can correct (move) the origin position by operating the origin position designation button 56.

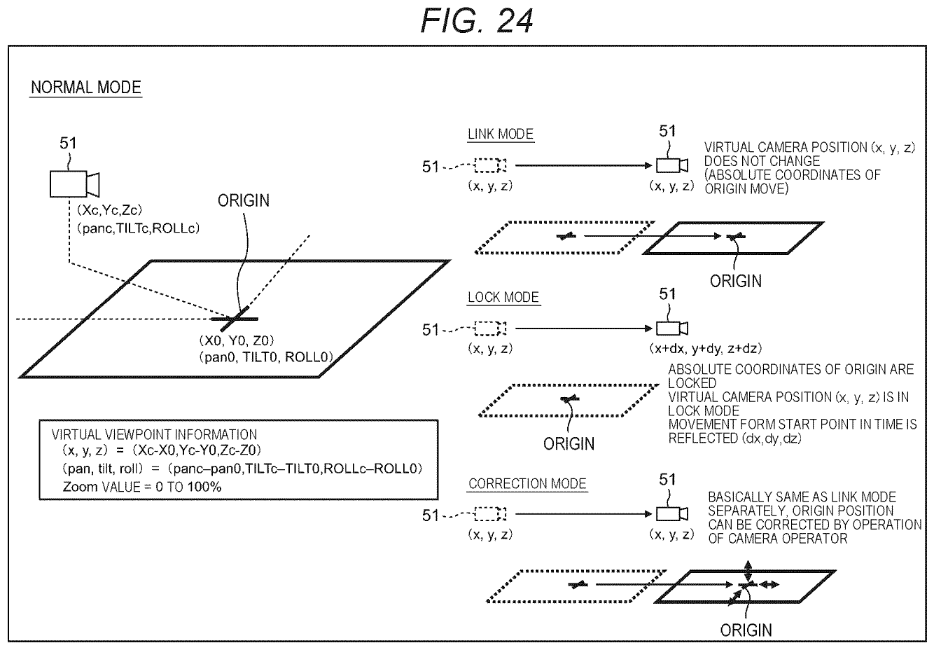

FIG. 24 illustrates a control example of the camera position of the virtual viewpoint information in each coordinate setting mode.

Since a normal mode on a left side of FIG. 24 is an example of the virtual viewpoint information of the first embodiment described in FIG. 5, the description thereof will be omitted.

In the link mode, even though the real camera 51 moves, a camera position (x, y, z) of the virtual viewpoint information does not change. Absolute coordinates of an origin position (X0, Y0, Z0) move.

In the lock mode, the absolute coordinates of the origin (X0, Y0, Z0) are fixed to the origin position at a start point in time of the lock mode. In a case where the real camera 51 is moved by a movement amount (dx, dy, dz), the camera position of the virtual viewpoint information is (x+dx, y+dy, z+dz), and the movement amount from a start point in time of the lock mode is reflected.

In the correction mode, basically, even though the real camera 51 moves similarly to the link mode, the camera position (x, y, z) of the virtual viewpoint information does not change. However, the origin position (X0, Y0, Z0) can be corrected (moved).

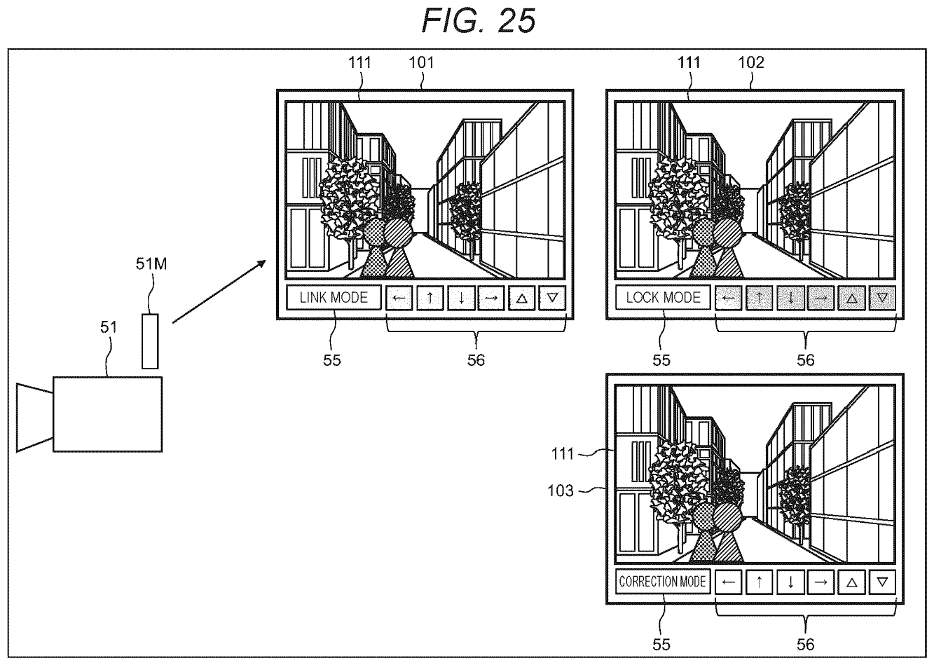

FIG. 25 illustrates an example of the mode selection button 55 and the origin position designation button 56.

In the example of FIG. 25, a mode selection button 55 and an origin position designation button 56 are provided, as a touch panel, in a monitor 51M of the real camera 51. Whenever the mode selection button 55 is pressed, the display of the link mode, the lock mode, and the correction mode is switched. The origin position designation button 56 includes a total of six movement buttons that move in a positive direction and a negative direction with respect to each of an x-axis, a y-axis, and a z-axis.

A screen 101 illustrates an example of a screen displayed on the monitor 51M of the real camera 51 in the link mode. In the link mode, since the origin position cannot be moved, the origin position designation button 56 is controlled to be inoperable.

A screen 102 illustrates an example of a screen displayed on the monitor 51M of the real camera 51 in the lock mode. In the lock mode, since the origin position cannot be moved, the origin position designation button 56 is controlled to be inoperable.

A screen 103 illustrates an example of a screen displayed on the monitor 51M of the real camera 51 in the correction mode. In the correction mode, since the origin position can be moved, the origin position designation button 56 is controlled to be operable.

The synthesized video (RGB) supplied from the video synthesizing device 31 in the video synthesizing center is displayed on a video display unit 111 of the screens 101 to 103.

### Virtual Viewpoint Information Generation Processing

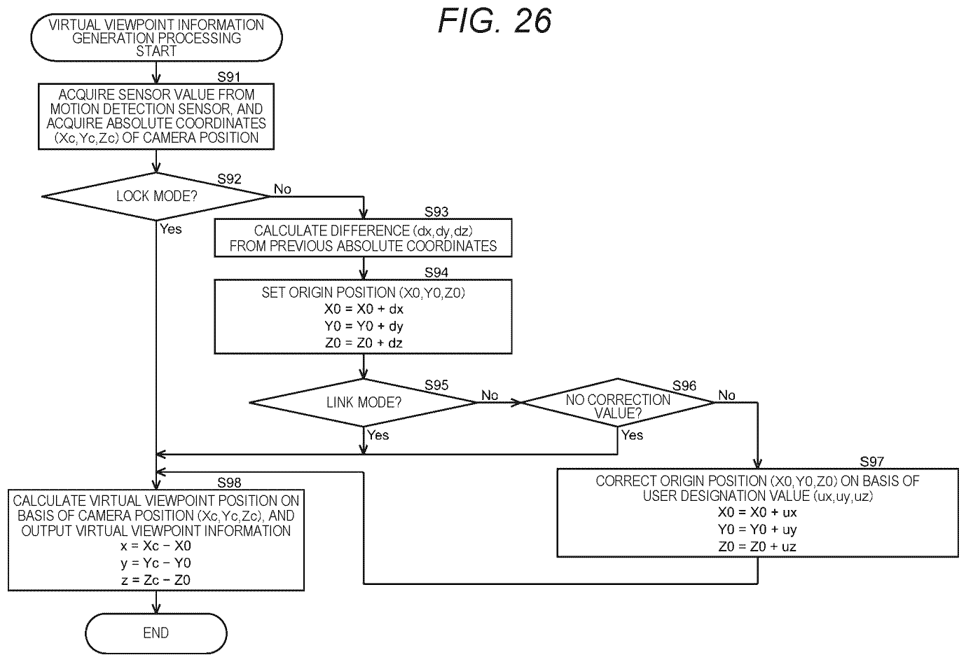

Virtual viewpoint information generation processing by the background video generation device 53 of the third embodiment will be described with reference to the flowchart of FIG. 26. This processing is started, for example, with the start of imaging in the background imaging system 11.
First, in step S91, the background video generation device 53 acquires a sensor value from the camera motion detection sensor 52 including a GPS, a gyro sensor, an acceleration sensor, and the like, and acquires absolute coordinates (Xc, Yc, Zc) of the camera position.
In step S92, the background video generation device 53 determines whether or not the current coordinate setting mode is the lock mode. In a case where it is determined in step S92 that the current coordinate setting mode is the lock mode, the processing proceeds to step S98 as described later.

Meanwhile, in a case where it is determined in step S92 that the current coordinate setting mode is not the lock mode, the processing proceeds to step S93, and the background video generation device 53 calculates a difference (dx, dy, dz) from previous absolute coordinates. Subsequently, in step S94, the background video generation device 53 sets the origin position (X0, Y0, Z0) to (X0+dx, Y0+dy, Z0+dz) by using the calculated difference (dx, dy, dz).

Next, in step S95, the background video generation device 53 determines whether or not the current coordinate setting mode is the link mode. In a case where it is determined in step S95 that the current coordinate setting mode is the link mode, the processing proceeds to step S98 as described later.

Meanwhile, in a case where it is determined in step S95 that the current coordinate setting mode is not the link mode, the processing proceeds to step S96, and the background video generation device 53 determines whether or not there is no correction value, that is, whether or not the origin position designation button 56 is operated. In a case where it is determined in step S96 that the origin position designation button 56 is not operated and there is no correction value, the processing proceeds to step S98 as described later.

Meanwhile, in a case where it is determined in step S96 that the origin position designation button 56 is operated and the origin position is designated by the user, the processing proceeds to step S97, and the background video generation device 53 corrects the origin position (X0, Y0, Z0) on the basis of a user-designated value (ux, uy, uz). The user-specified value (ux, uy, uz) is a position specified by the user with the origin position designation button 56, and a corrected origin position (X0, Y0, Z0) is (X0+ux, Y0+uy, Z0+uz).

In step S98, the background video generation device 53 calculates the virtual viewpoint position on the basis of the camera position (Xc, Yc, Zc), and outputs the virtual viewpoint information. In a case where the position of the real camera 51 is (Xc, Yc, Zc), the camera position (x, y, z) as the virtual viewpoint information is calculated by (Xc−X0, Yc−Y0, Zc−Z0). Then, the background video generation device 53 outputs, as the virtual viewpoint information, the calculated virtual viewpoint position (Xc−X0, Yc−Y0, Zc−Z0) together with the orientation (pan, tilt, roll) of the real camera 51 and the zoom value to the volumetric 2D video generation device 22.

Thus, the virtual viewpoint information generation processing in FIG. 26 is ended. This processing is periodically repeated at a predetermined cycle.

According to the third embodiment of the image processing system 1 described above, the origin position can be moved in accordance with the movement of the real camera 51 at a location site or the like. Therefore, in a case where the background video (RGB-D) is imaged while moving the real camera 51, it is possible to generate a natural synthesized video (RGB) with the volumetric 2D video (RGB-D) of the volumetric studio.

### Example of Smartphone or Drone

In the third embodiment, a full-blown background imaging camera equivalent to the camera used in the background imaging studio may be used, but a smartphone camera may be used as the real camera 51 used in the outdoor environment. Furthermore, a camera of a drone capable of imaging from above may be used.

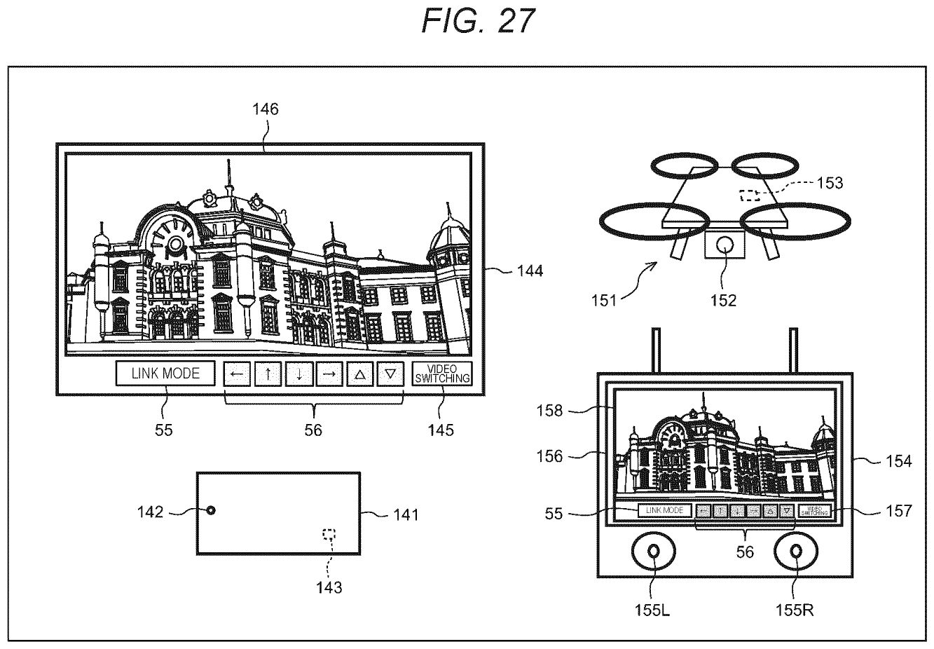

FIG. 27 illustrates a configuration example of the camera motion detection sensor 52, the mode selection button 55, the origin position designation button 56, and the like in a case where the smartphone or the drone is used as the real camera 51.

A left side of FIG. 27 illustrates an appearance of a smartphone 141 and a display screen example of a display 144 of the smartphone 141.

A camera 142 disposed on a back surface side of the smartphone 141 is used as the real camera 51 that images the subject and generates the background video (RGB) and the background video (Depth). A body of the smartphone 141 incorporates a sensor unit 143 such as a GPS, a gyro sensor, and an acceleration sensor, and the sensor unit 143 functions as the camera motion detection sensor 52.

The mode selection button 55, the origin position designation button 56, a video switching button 145, a video display unit 146, and the like are disposed on the display 144 of the smartphone 141.

The video switching button 145 is a button for switching a video displayed on the video display unit 146. In the video display unit 146, whenever the video switching button 145 is pressed, the video imaged by the camera 142 and the synthesized video (RGB) supplied from the video synthesizing device 31 can be alternately switched. The video display unit 146 displays one of the video imaged by the camera 142 and the synthesized video (RGB) supplied from the video synthesizing device 31 in accordance with a setting state of the video switching button 145.

The smartphone is used as the real camera 51, and thus, even in an environment where the full-blown background imaging camera cannot be prepared, it is possible to deliver the synthesized video (RGB) that produces a live feeling by using a live-action video of an imaging place in real time.

On a right side of FIG. 27, an example of a drone 151 and a controller 154 that operates the drone 151 is illustrated.

A camera 152 disposed on a predetermined surface of the drone 151 is used as the real camera 51 that images the subject and generates the background video (RGB) and the background video (Depth). A body of the drone 151 incorporates a sensor unit 153 such as a GPS, a gyro sensor, and an acceleration sensor, and the sensor unit 153 functions as the camera motion detection sensor 52.

Joysticks 155R and 155L and a display 156 are provided in the controller 154. The joysticks 155R and 155L are operation units that control the motion of the drone 151. The mode selection button 55, the origin position designation button 56, a video switching button 157, a video display unit 158, and the like are disposed on the display 156.

The video switching button 157 is a button for switching a video displayed on the video display unit 158. In the video display unit 158, whenever the video switching button 157 is pressed, the video imaged by the camera 152 and the synthesized video (RGB) supplied from the video synthesizing device 31 can be alternately switched. The video display unit 158 displays one of the video imaged by the camera 152 and the synthesized video (RGB) supplied from the video synthesizing device 31 in accordance with a setting state of the video switching button 157.

The camera 152 of the drone 151 is used as the real camera 51, and thus, even at a place or an environment where the real camera 51 cannot be disposed, it is possible to deliver the synthesized video (RGB) that produces a live feeling by using a live-action video of an imaging place in real time.

### 11. Fourth embodiment of Image Processing System

Next, a fourth embodiment of the image processing system will be described.

In the fourth embodiment, the image processing system 1 has a configuration in which an illumination environment of the background imaging studio or the location site where background imaging is performed can be reflected in the volumetric studio.

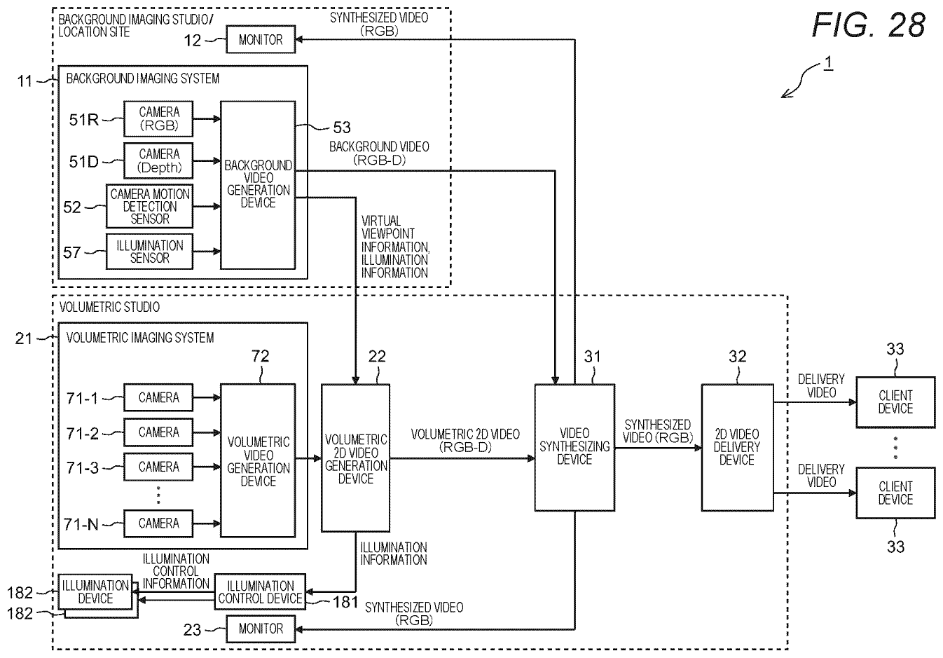

FIG. 28 is a block diagram illustrating the fourth embodiment of the image processing system to which the present technology is applied.

In the drawings of the fourth embodiment, parts corresponding to the first embodiment illustrated in FIG. 3 are denoted by the same reference signs, and description of the parts will be omitted as appropriate, focusing on description of different parts.

In the fourth embodiment, an illumination sensor 57 is provided in the background imaging system 11 in addition to the camera 51R, the camera 51D, the camera motion detection sensor 52, and the background video generation device 53, which are similar to the first embodiment.

The illumination sensor 57 includes a plurality of illuminance sensors, acquires an illuminance value of a periphery of 360°, and supplies the acquired illuminance value to the background video generation device 53. The illuminance value is, for example, a value within a range of 0 to 100%.

The background video generation device 53 acquires the illuminance value of each of the plurality of illuminance sensors supplied from the illumination sensor 57, and supplies, as illuminance information, the illuminance value together with the virtual viewpoint information to the volumetric 2D video generation device 22.

An illumination control device 181 and a plurality of illumination devices 182 are additionally provided in the volumetric studio. Furthermore, the video synthesizing device 31 and the 2D video delivery device 32 are also disposed in the volumetric studio.

The volumetric 2D video generation device 22 supplies the illuminance information supplied from the background video generation device 53 of the background imaging system 11 to the illumination control device 181.

The illumination control device 181 generates illumination control information for controlling the plurality of illumination devices 182 on the basis of the illuminance information from the volumetric 2D video generation device 22, and supplies the illumination control information to each of the plurality of illumination devices 182. The number and positions of the illuminance sensors included in the illumination sensor 57 may not coincide with the number and positions of the illumination devices 182 installed in the volumetric studio. The illumination control device 181 generates illumination control information of each of the plurality of illumination devices 182 installed in the volumetric studio on the basis of the acquired illuminance information to reproduce the illumination environment of the background imaging studio. The illumination control information is a control signal for controlling light emission luminance when the illumination device 182 emits light, and the illumination device 182 emits light with a predetermined light emission luminance on the basis of the illumination control information from the illumination control device 181.

Other configurations of the fourth embodiment are similar to the first embodiment described above. The image processing system 1 of the fourth embodiment has the above configuration.

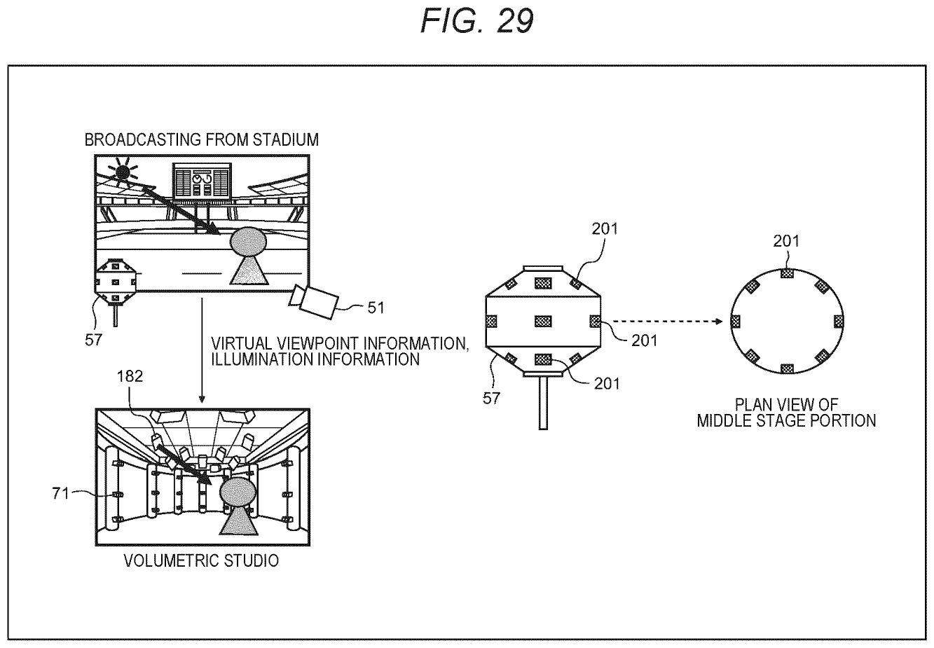

The illuminance information acquired by the illumination sensor 57 and the illumination control information for controlling the illumination device 182 will be described with reference to FIG. 29.

For example, as illustrated in FIG. 29, the illumination sensor 57 is installed beside the real camera 51 in the background imaging studio or the location site. In the illumination sensor 57, a plurality of illuminance sensors 201 is disposed at an upper stage, an interruption, and a lower stage of a substantially spherical shape such that intensity of illumination from various orientations can be measured.

Each illuminance sensor 201 of the illumination sensor 57 outputs, as the illuminance information, (sensor No, pan, tilt, brightness) to the background video generation device 53. The “sensor No” represents an identification number for identifying the illuminance sensor 201, the “pan” represents an orientation of the illuminance sensor 201 in the left-right direction, and the “tilt” represents the orientation of the illuminance sensor 201 in the up-down direction. The brightness represents an illuminance value detected by the illuminance sensor 201.

In this example, for the sake of simplicity, the number of illuminance sensors 201 provided in the illumination sensor 57 is K (K>0), and the number of illumination devices 182 installed in the volumetric studio is also K, which is the same as the number of illuminance sensors 201. Furthermore, among the K illumination devices 182, an orientation of the illumination device 182 having the same illumination No as the sensor No corresponds to an orientation of the illuminance sensor 201 having the same sensor No. In other words, each illumination device 182 has (illumination No, pan, tilt) as the illumination information, and the “pan” and the “tilt” of the illumination device 182 of which the illumination No is k (an integer of k=1 to K) are the same as the “pan” and the “tilt” of the illuminance sensor 201 of which the sensor No is k. In this case, the illumination control device 181 can generate the illumination control information of the illumination device 182 of which the illumination No is k on the basis of the “brightness” of the illuminance information of the illuminance sensor 201 of which the sensor No is k.

Note that, in a case where the number and orientation of the illuminance sensors 201 are different from the number and orientation of the illumination devices 182, the illumination control information can be analytically obtained by using the illuminance information of each illuminance sensor 201 and the illumination information of each illumination device 182.

### Illumination Control Processing

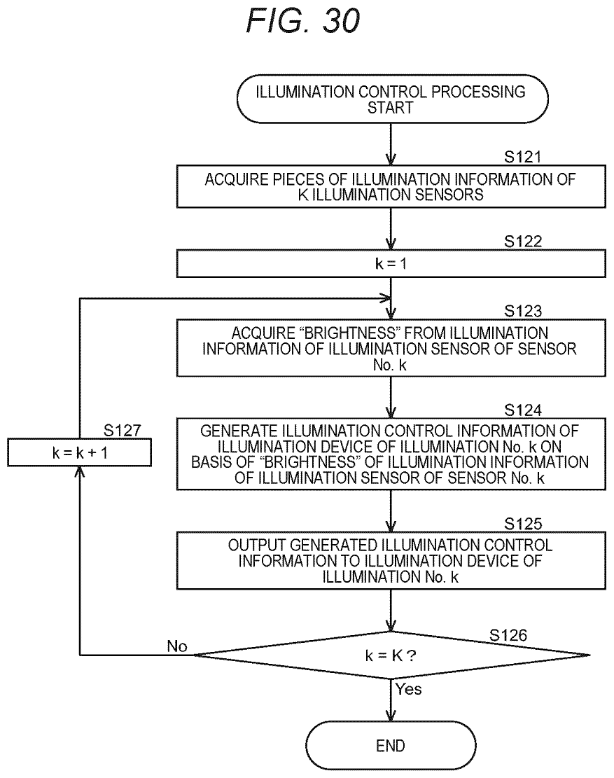

Next, illumination control processing by the image processing system 1 of the fourth embodiment will be described with reference to the flowchart of FIG. 30. This processing is started, for example, with the start of imaging in the background imaging system 11.
First, in step S121, the background video generation device 53 of the background imaging system 11 acquires the pieces of illumination information of the K illuminance sensors supplied from the illumination sensor 57. The background video generation device 53 supplies, as the illuminance information, the illuminance value of each of the K illuminance sensors together with the virtual viewpoint information to the volumetric 2D video generation device 22. The illumination information supplied to the volumetric 2D video generation device 22 is output to the illumination control device 181.
In step S122, the illumination control device 181 substitutes 1 into a variable k for identifying the illumination No.
In step S123, the illumination control device 181 acquires the “brightness” from the illuminance information of the illuminance sensor 201 of a sensor No.k.
In step S124, the illumination control device 181 generates the illumination control information of the illumination device 182 of the illumination No.k on the basis of the “brightness” of the illuminance information of the illuminance sensor 201 of the sensor No.k.
In step S125, the illumination control device 181 outputs the generated illumination control information to the illumination device 182 of the illumination No.k. Therefore, the illumination device 182 of the illumination No.k emits light with predetermined light emission luminance on the basis of the illumination control information.
In step S126, the illumination control device 181 determines whether or not the variable k is equal to the number K of illumination devices 182. In a case where it is determined in step S126 that the variable k is not equal to the number K of illumination devices 182, in other words, the variable k is smaller than the number K, the processing proceeds to step S127, and the variable k is incremented by 1. Then, the processing returns to step S123, and the processing of steps S123 to S126 described above is executed on the next illumination device 182.

Meanwhile, in a case where it is determined in step S126 that the variable k is equal to the number K of illumination devices 182, the illumination control processing of FIG. 30 is ended.

The illumination control processing of FIG. 30 corresponds to processing of performing light emission control once for the K illumination devices 182. The illumination control processing of FIG. 30 is repeatedly executed until imaging in the background imaging system 11 is finished.

According to the fourth embodiment of the image processing system 1 described above, the illumination environment of the background imaging studio or the location site where the background imaging is performed is reflected in the volumetric studio. Therefore, the volumetric 2D video (RGB-D) in which the illumination environment of the background imaging studio or the location site is reflected can be generated.

### 12. Fifth Embodiment of Image Processing System

Next, a fifth embodiment of the image processing system will be described.

In the first embodiment described above, in order to facilitate distinction between the person ACT2 who is the performer of the 3D model data generation target and the others, the volumetric studio is green back. However, in the environment of the green back, the performer cannot feel the realistic feeling of the site, and it is difficult to perform. Accordingly, in the fifth embodiment, the image processing system 1 is formed such that the performer in the volumetric studio can feel a realistic feeling at the site by disposing a wall surface display to surround the person ACT2 in the volumetric studio and projecting the video of the background imaging studio or the location site on the wall surface display.

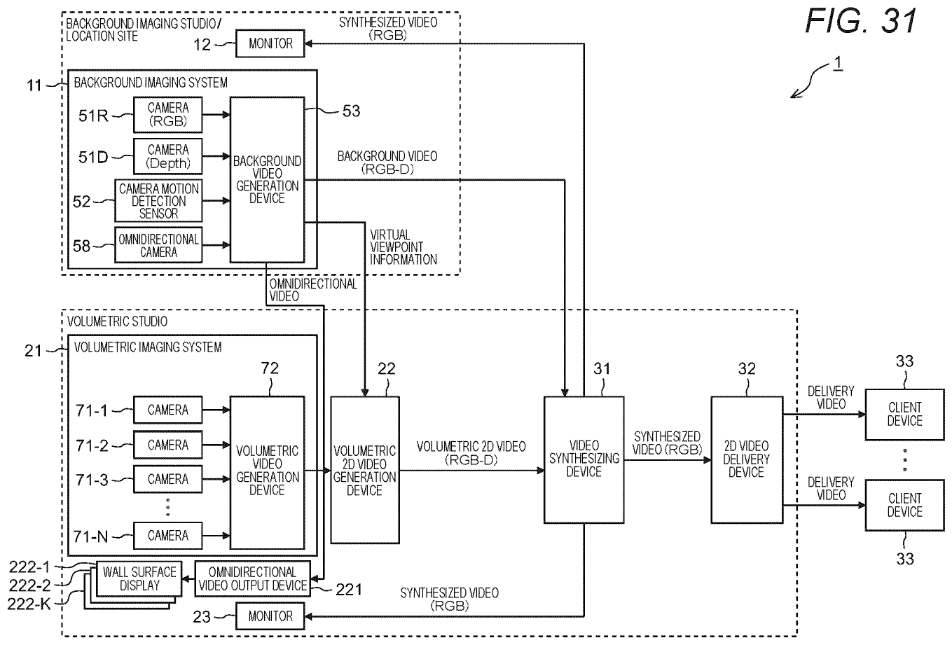

FIG. 31 is a block diagram illustrating the fifth embodiment of the image processing system to which the present technology is applied.

In the drawings of the fifth embodiment, parts corresponding to the first embodiment illustrated in FIG. 3 are denoted by the same reference signs, and description of the parts will be omitted as appropriate, focusing on description of different parts.

In the fifth embodiment, an omnidirectional camera 58 is provided in the background imaging system 11 in addition to the camera 51R, the camera 51D, the camera motion detection sensor 52, and the background video generation device 53, which are similar to the first embodiment. The omnidirectional camera 58 is a camera that images an omnidirectional video for enabling the performer of the volumetric studio to grasp a situation of the background imaging studio or the location site while having a realistic feeling.

Meanwhile, an omnidirectional video output device 221 and a plurality of (K) wall surface displays 222-1 to 222-K are additionally provided in the volumetric studio. Furthermore, the video synthesizing device 31 and the 2D video delivery device 32 are also disposed in the volumetric studio.

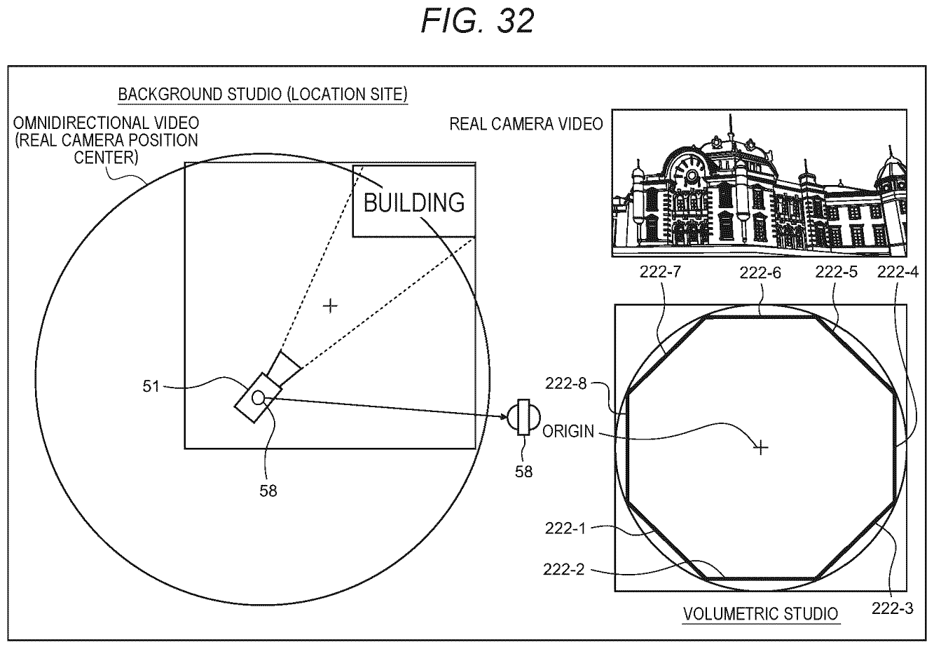

FIG. 32 illustrates a disposition example of the real camera 51 and the omnidirectional camera 58 in the background imaging studio or the location site, and the K wall surface displays 222-1 to 222-K in a volumetric studio.

For example, as illustrated in FIG. 32, the omnidirectional camera 58 is disposed such that an angle of view thereof does not fall within an angle of view of the real camera 51, such as an upper portion of the real camera 51. The omnidirectional camera 58 images a periphery around the real camera 51 and supplies an omnidirectional image obtained as a result of the imaging to the background video generation device 53. The omnidirectional camera 58 may be disposed at a place different from the real camera 51.

The K wall surface displays 222-1 to 222-K are disposed around the origin to surround the volumetric studio. The example of FIG. 32 illustrates an example in which eight wall surface displays 222-1 to 222-8 are disposed around the volumetric studio with K=8.

Referring back to the description of FIG. 31, the background video generation device 53 supplies the omnidirectional video supplied from the omnidirectional camera 58 to the omnidirectional video output device 221 of the volumetric studio.

The omnidirectional video output device 221 generates a video signal for reprojecting the omnidirectional video supplied from the background video generation device 53 in accordance with the K (K>0) wall surface displays 222-1 to 222-K. Information regarding the position, orientation, and size of each of the K wall surface displays 222-1 to 222-K is given to the omnidirectional video output device 221. The omnidirectional video output device 221 supplies video signals generated corresponding to the dispositions of the wall surface displays 222-1 to 222-K to the wall surface displays 222-1 to 222-K.

Each of the wall surface displays 222-1 to 222-K displays (a part of) the omnidirectional video on the basis of the video signal from the omnidirectional video output device 221. A synchronization signal generated by the omnidirectional video output device 221 is input to the wall surface displays 222-1 to 222-K, and the K wall surface displays 222-1 to 222-K synchronously display the omnidirectional video.

Note that, in the generation of the 3D model data of the person ACT2 who is the performer performed by the volumetric video generation device 72, the omnidirectional video displayed on the wall surface displays 222-1 to 222-K is appropriately canceled.

### Omnidirectional Video Output Processing

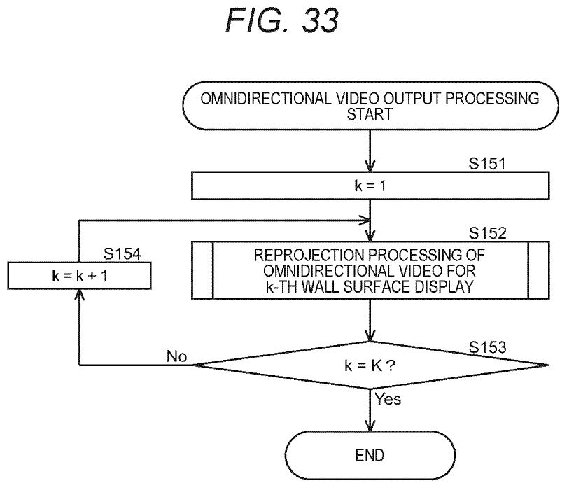

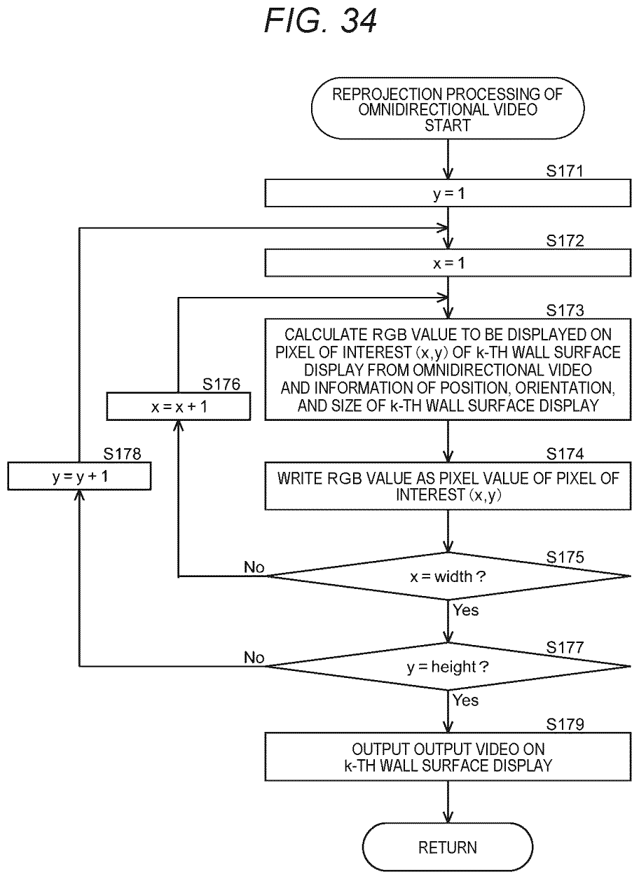

Omnidirectional video output processing of displaying, by the omnidirectional video output device 221, the omnidirectional video on the K wall surface displays 222 in the image processing system 1 of the fifth embodiment will be described with reference to the flowchart of FIG. 33. This processing is started, for example, when the omnidirectional video is input from the background video generation device 53 to the omnidirectional video output device 221.
First, in step S151, the omnidirectional video output device 221 substitutes 1 into a variable k for identifying the K wall surface displays 222.
In step S152, the omnidirectional video output device 221 executes reprojection processing of the omnidirectional video for reprojecting the omnidirectional video on a k-th wall surface display 222 (wall surface display 222-k). Details of the reprojection processing of the omnidirectional video will be described later with reference to the flowchart of FIG. 34.
In step S153, the omnidirectional video output device 221 determines whether or not the variable k is equal to the number K of wall surface displays 222. In a case where it is determined in step S153 that the variable k is not equal to the number K of wall surface displays 222, in other words, the variable k is smaller than the number K, the processing proceeds to step S154, and the variable k is incremented by 1. Then, the processing returns to step S152, and the processing of steps S152 and S153 described above is executed on the next wall surface display 222.

Meanwhile, in a case where it is determined in step S153 that the variable k is equal to the number K of wall surface displays 222, the omnidirectional video output processing of FIG. 33 is ended.

FIG. 34 is a flowchart illustrating details of the reprojection processing of the omnidirectional video executed as step S152 of FIG. 33.

First, the omnidirectional video output device 221 sets 1 to the y coordinate for determining the pixel of interest (x, y) of the output video for the k-th wall surface display 222 in step S171, and sets 1 to the x coordinate in step S172.
In step S173, the omnidirectional video output device 221 calculates the RGB value that is color information to be displayed on the pixel of interest (x, y) of the k-th wall surface display 222 from the omnidirectional video and the information of the position, orientation, and size of the k-th wall surface display 222.
In step S174, the omnidirectional video output device 221 writes the RGB value obtained by calculation as the pixel value of the pixel of interest (x, y) of the k-th wall surface display 222.
In step S175, the omnidirectional video output device 221 determines whether or not the value of the x coordinate of the current pixel of interest (x, y) is the same as the width width of the video size of the output video.

In a case where it is determined in step S175 that the value of the x coordinate of the current pixel of interest (x, y) is not the same as the width width of the video size of the output video, the processing proceeds to step S176, and the value of the x coordinate is incremented by 1. Thereafter, the processing returns to step S173, and the processing of steps S173 to S175 described above is repeated. That is, processing of calculating and writing the RGB value that is the color information to be displayed is performed with another pixel in the same row of the output video as the pixel of interest (x, y).

Meanwhile, in a case where it is determined in step S175 that the value of the x coordinate of the current pixel of interest (x, y) is the same as the width width of the video size of the output video, the processing proceeds to step S177, and the omnidirectional video output device 221 determines whether or not the value of the y coordinate of the current pixel of interest (x, y) is the same as the height height of the video size of the output video.

In a case where it is determined in step S177 that the value of the y coordinate of the current pixel of interest (x, y) is not the same as the height height of the video size of the output video, the processing proceeds to step S178, and the value of the y coordinate is incremented by 1. Thereafter, the processing returns to step S172, and the processing of steps S172 to S177 described above is repeated. That is, the processing of steps S172 to S177 described above is repeated until all the rows of the output video are set as the pixel of interest (x, y).

In a case where it is determined in step S177 that the value of the y coordinate of the current pixel of interest (x, y) is the same as the height height of the video size of the output video, the processing proceeds to step S179, and the omnidirectional video output device 221 outputs the video signal of the output video in which the RGB values of all the pixels are written to the k-th wall surface display 222.

As described above, the reprojection processing of the omnidirectional video executed as step S152 of FIG. 33 is ended, and the processing proceeds to step S153 of FIG. 33.

According to the fifth embodiment of the image processing system 1 described above, it is possible to display a peripheral video imaged by the omnidirectional camera 58 separately from the real camera 51 in the background imaging studio or the location site around the performer of the volumetric studio. Therefore, the performer of the volumetric studio can perform while feeling the realistic feeling of the background imaging studio or the location site.

### 13. Summary of Image Processing System of Present Disclosure

According to the image processing system 1 according to the first to fifth embodiments described above, the background imaging system 11 generates the background video (RGB-D) imaged in the background imaging studio, the location site, or the like, and supplies the background video to the video synthesizing device 31. Furthermore, the volumetric 2D video generation device 22 generates the volumetric 2D video (RGB-D) of the 3D model of the person in the volumetric studio viewed from the predetermined virtual viewpoint (viewpoint of the virtual camera), and supplies the generated video to the video synthesizing device 31. As the viewpoint of the virtual camera at this time, the volumetric 2D video generation device 22 generates the volumetric 2D video (RGB-D) by using the viewpoint of the real camera 51 (stereo camera 54) of the background imaging system 11. The video synthesizing device 31 generates the synthesized video (RGB) by synthesizing the background video (RGB-D) generated by the background imaging system 11 with the volumetric 2D video (RGB-D) generated by the volumetric 2D video generation device 22. The synthesized video (RGB) is generated on the basis of the depth information of each of the background video (RGB-D) and the volumetric 2D video (RGB-D) with priority given to the subject on the closer side. The 2D video delivery device 32 transmits (delivers) the synthesized video (RGB) as the delivery video to the client device 33 of a viewing client.

The background video (RGB) imaged by the real camera 51 is used as the background video of the person who is a performer of the volumetric studio, and thus, it is possible to generate the 2D video as if the person in the volumetric studio is in the background imaging studio, the location site, or the like where the real camera 51 is present and transmit the 2D video to the client device 33.

Since it is not necessary to create the 3D CG image for the background by using the background video imaged by the real camera 51, it is possible to immediately deliver the image at low cost. The imaging of the background video is only required to have only the real camera 51 and an acquisition function of the position, orientation, zoom value, and the like of the real camera 51, advanced imaging equipment is unnecessary, and the background video (RGB-D) can be imaged at any place. Therefore, it is possible to easily create the delivery video as if the performer is actually present at various imaging places. Since the position, orientation, zoom value, and the like of the real camera 51 are acquired as the virtual viewpoint information and the volumetric 2D video (RGB-D) is generated, when the real camera 51 moves, zooms, and the like, changes in the background video and the video of the performer are exactly matched, and thus, it is possible to allow the viewing client to feel natural without giving a feeling of the synthesized video. The imaging place of the background video is not limited to the studio, and may be an outdoor place such as a place where an incident has occurred or a site of a sport or an event. The live-action video of the imaging location is used, it is possible to produce a live feeling and to take advantage of a real-time imaging video. It is possible to realize 2D delivery capable of producing a live feeling and a realistic feeling at low cost.

Note that, in each of the embodiments described above, the image processing system 1 is formed such that the background imaging system 11 can acquire not only the 2D video of the background but also the depth information, can compare the distance to the subject with the volumetric 2D video (RGB-D), and can generate the synthesized video (RGB).

However, at the imaging place or the like that does not fail even though the 2D video imaged by the background imaging system 11 is constantly used as the background, the background imaging system 11 may generate only the 2D video serving as the background and omit the output of the depth information. In this case, the video synthesizing device 31 generates the synthesized video (RGB) by synthesizing the volumetric 2D video (RGB) generated by the volumetric 2D video generation device 22 and the foreground and the background video (RGB) generated by the background imaging system 11 as the background.

### About System Configuration of Image Processing System

In the image processing system 1, the background imaging system 11 is installed at a first place such as the background imaging studio or the location site, and the volumetric imaging system 21 and the volumetric 2D video generation device 22 are installed in the volumetric studio that is a second place different from the first place.

On the other hand, the video synthesizing device 31 and the 2D video delivery device 32 of the image processing system 1 may be installed in any place, and as in the first embodiment, the video synthesizing device 31 may be installed in the video synthesizing center, and the 2D video delivery device 32 may be installed in the delivery center. Alternatively, the video synthesizing device 31 and the 2D video delivery device 32 may be installed in the same background imaging studio or location site as the background imaging system 11, or may be installed in the same volumetric studio as the volumetric imaging system 21 and the volumetric 2D video generation device 22.

In a case where the video synthesizing device 31 and the 2D video delivery device 32 are installed at the same place as the background imaging system 11, one image processing apparatus including a background video generation unit, a video synthesizing unit, and a 2D video delivery unit, as the functions of the background video generation device 53, the video synthesizing device 31, and the 2D video delivery device 32, may be provided. Alternatively, the background video generation device 53 and the video synthesizing device 31 may be formed as one image processing apparatus.

In a case where the video synthesizing device 31 and the 2D video delivery device 32 are installed at the same place as the volumetric imaging system 21, one image processing apparatus including a volumetric 2D video generation unit, a video synthesizing unit, and a 2D video delivery unit, as the functions of the volumetric 2D video generation device 22, the video synthesizing device 31, and the 2D video delivery device 32, may be provided. Alternatively, the volumetric 2D video generation device 22 and the video synthesizing device 31 may be configured by one image processing apparatus.

### 14. Computer Configuration Example

The above-described series of processing can be executed by hardware or software. In a case where the series of processing is executed by the software, a program that configures the software is installed in a computer. Here, examples of the computer include, for example, a microcomputer that is built in dedicated hardware, a general-purpose personal computer that can perform various functions by being installed with various programs, and the like.

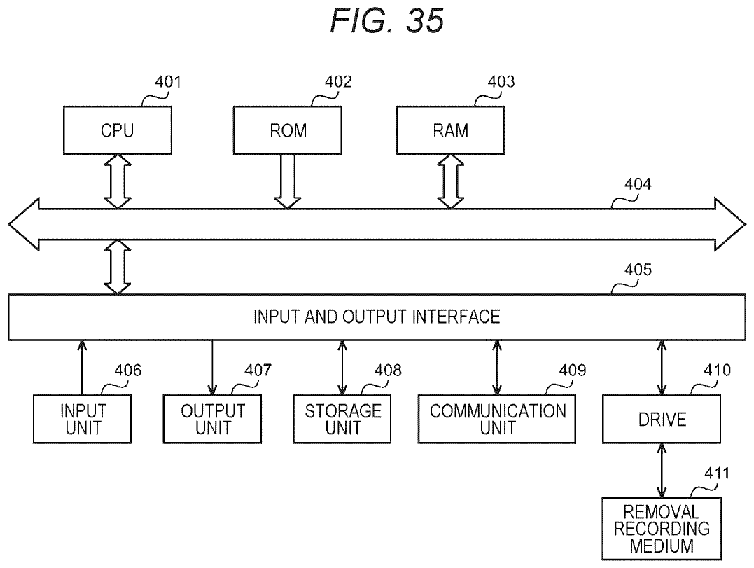

FIG. 35 is a block diagram illustrating a configuration example of hardware of a computer that executes the above-described series of processes by a program.

In the computer, a central processing unit (CPU) 401, a read only memory (ROM) 402, and a random access memory (RAM) 403 are mutually connected by a bus 404.

An input and output interface 405 is further connected to the bus 404. An input unit 406, an output unit 407, a storage unit 408, a communication unit 409, and a drive 410 are connected to the input and output interface 405.

The input unit 406 includes a keyboard, a mouse, a microphone, a touch panel, an input terminal, and the like. The output unit 407 includes a display, a speaker, an output terminal, and the like. The storage unit 408 includes a hard disk, a RAM disk, a non-volatile memory, or the like. The communication unit 409 includes a network interface and the like. The drive 410 drives a removable recording medium 411 such as a magnetic disk, an optical disk, a magneto-optical disk, or a semiconductor memory.

In the computer having the above configuration, for example, the CPU 401 loads a program stored in the storage unit 408 into the RAM 403 via the input and output interface 405 and the bus 404 and executes the program, such that the above-described series of processing is performed. Furthermore, the RAM 403 also appropriately stores data necessary for the CPU 401 to perform various types of processing, and the like.

The program executed by the computer (CPU 401) can be provided by being recorded on the removable recording medium 411 as a package medium and the like, for example. Furthermore, the program can be provided via a wired or wireless transmission medium such as a local area network, the Internet, or digital satellite broadcasting.

In the computer, the removable recording medium 411 is mounted in the drive 410, such that the programs can be installed into the storage unit 408 via the input and output interface 405. Furthermore, the program can be received by the communication unit 409 via a wired or wireless transmission medium, and installed in the storage unit 408. In addition, the program can be installed in the ROM 402 or the storage unit 408 in advance.

Note that, meanwhile, the program executed by the computer may be the program of which processes are performed in chronological order in the order described in this specification or may be the program of which processes are performed in parallel or at required timing such as when a call is issued.

In the present specification, the steps described in the flowcharts may be executed not only, needless to say, in time series in the described order, but also in parallel or as needed at a timing when a call is made, or the like, even if not processed in time series.

In the present description, a system means a set of a plurality of components (devices, modules (parts), and the like), and it does not matter whether or not all the components are in the same housing. Therefore, a plurality of devices housed in separate housings and connected to each other via a network and one device in which a plurality of modules is housed in one housing are both systems.

The embodiment of the present disclosure is not limited to the above-described embodiments and various modifications may be made without departing from the gist of the technique of the present disclosure.

For example, it is possible to adopt a mode obtained by combining all or some of the plurality of embodiments described above.

For example, the technique according to the present disclosure can provide a configuration of cloud computing in which one function is shared and processed by a plurality of devices cooperating with each other via a network.

Furthermore, each step described in the flowchart described above can be performed by one device or can be shared and performed by a plurality of devices.

Moreover, in a case where a plurality of pieces of processing is included in one step, the plurality of pieces of processing included in the one step can be executed by one device or executed by a plurality of devices in a shared manner. Note that, the effects described in the present specification are merely examples and are not limited, and there may be effects other than those described in the present specification.

Note that, the technique of the present disclosure can have the following configurations.

(1)

An image processing apparatus includes a 2D video generation unit that acquires, as virtual viewpoint information, camera positional information of a camera that performs imaging at a first place, and generates a 2D video obtained by viewing a 3D model of a person generated by performing imaging at a second place different from the first place from a viewpoint of the camera.

(2)

In the image processing apparatus according to the above (1), the 2D video generation unit generates a 2D video and a depth video of the person viewed from the viewpoint of the camera.

(3)

In the image processing apparatus according to any one of the above (1) or (2), a frame number is included in the virtual viewpoint information, and the 2D video generation unit assigns the frame number to the generated 2D video, and output the 2D video.

(4)

The image processing apparatus according to any one of the above (1) to (3) further includes a video synthesizing unit that generates a synthesized image obtained by synthesizing the 2D video generated by the 2D video generation unit and a 2D video generated by the camera.

(5)

In the image processing apparatus according to the above (4), the video synthesizing unit selects a closer subject from the 2D video generated by the 2D video generation unit and the 2D video generated by the camera, and generates the synthesized image.

(6)

In the image processing apparatus according to the above (4) or (5), the video synthesizing unit generates the synthesized image by synthesizing the 2D video generated by the 2D video generation unit and the 2D video generated by the camera, which have the same frame number.

(7)

The image processing apparatus according to any one of the above (1) to (6) further includes a plurality of the 2D video generation units, and a plurality of the 2D video generation units acquires, as the virtual viewpoint information, pieces of camera positional information from different cameras, and generates 2D videos.

(8)

The image processing apparatus according to any one of the above (1) to (6), further includes a plurality of the 2D video generation units, and a plurality of the 2D video generation units acquires, as the virtual viewpoint information, camera positional information from the same camera, and generates 2D videos.

(9)

The image processing apparatus according to any one of the above (1) to (8), further includes a plurality of video synthesizing units that synthesize 2D videos generated by a plurality of the 2D video generation units and 2D videos imaged by a plurality of the cameras.

(10)

The image processing apparatus according to the above (9) further includes a selection unit that selects any one of a plurality of synthesized images generated by the plurality of video synthesizing units, and outputs the selected synthesized image.

(11)

In the image processing apparatus according to any one of the above (1) to (10), the camera is a camera that outputs a 2D video and a depth video.

(12)

In the image processing apparatus according to any one of the above (1) to (11), an imaging system including the camera includes a mode selection unit that switches between a mode in which an origin position moves in conjunction with movement of the camera, a mode in which the origin position is fixed, and a mode in which the origin position is able to be corrected.

(13)

In the image processing apparatus according to any one of the above (1) to (12), the camera is a camera of a smartphone.

(14)

In the image processing apparatus according to any one of the above (1) to (12), the camera is a camera of a drone.

(15)

In the image processing apparatus according to any one of the above (1) to (14), the 2D video generation unit acquires illumination information of the first place, and outputs the acquired illumination information to an illumination control device that controls an illumination device at the second place.

(16)

In the image processing apparatus according to any one of the above (1) to (15), an imaging system including the camera includes a second camera that images a periphery of the camera, and a video of the second camera is configured to be displayed on a display of the second place.

(17)

In the image processing apparatus according to any one of the above (1) to (16), the 2D video generation unit acquires the virtual viewpoint information by using a FreeD protocol.

(18)

An image processing system includes a 2D video generation device that acquires, as virtual viewpoint information, camera positional information of a camera that performs imaging at a first place, and generates a 2D video obtained by viewing a 3D model of a person generated by performs imaging at a second place different from the first place from a viewpoint of the camera, and a video synthesizing device that generates a synthesized image obtained by synthesizing a 2D video generated by the 2D video generation device and a 2D video generated by the camera.

### REFERENCE SIGNS LIST

1 Image processing system
11 Background imaging system
21 Volumetric imaging system
22 Volumetric 2D video generation device
31 Video synthesizing device
32 2D video delivery device
33 Client device
51D Camera
51R Camera
52 Camera motion detection sensor
53 Background video generation device
54 Stereo camera
55 Mode selection button
56 Origin position designation button
57 Illumination sensor
58 Omnidirectional camera
71-1 to 71-N Camera
72 Volumetric video generation device
73 Virtual camera
81 Switcher
82 Synthesized video selection device
141 Smartphone
142 Camera
151 Drone
152 Camera
181 Illumination control device
182 Illumination device
201 Illuminance sensor
221 Omnidirectional video output device
222-1 to 222-k Wall surface display
402 ROM
404 Bus
405 Input and output interface
406 Input unit
407 Output unit
408 Storage unit
409 Communication unit
410 Drive
411 Removable recording medium
ACT1 to ACT3 Person

1. An image processing apparatus comprising:
a 2D video generation unit that acquires, as virtual viewpoint information, camera positional information of a camera that performs imaging at a first place, and generates a 2D video obtained by viewing a 3D model of a person generated by performing imaging at a second place different from the first place from a viewpoint of the camera.

2. The image processing apparatus according to claim 1, wherein the 2D video generation unit generates a 2D video and a depth video of the person viewed from the viewpoint of the camera.

3. The image processing apparatus according to claim 1, wherein a frame number is included in the virtual viewpoint information, and
the 2D video generation unit assigns the frame number to the generated 2D video, and output the 2D video.

4. The image processing apparatus according to claim 1, further comprising:
a video synthesizing unit that generates a synthesized image obtained by synthesizing the 2D video generated by the 2D video generation unit and a 2D video generated by the camera.

5. The image processing apparatus according to claim 4, wherein the video synthesizing unit selects a closer subject from the 2D video generated by the 2D video generation unit and the 2D video generated by the camera, and generates the synthesized image.

6. The image processing apparatus according to claim 4, wherein the video synthesizing unit generates the synthesized image by synthesizing the 2D video generated by the 2D video generation unit and the 2D video generated by the camera, which have the same frame number.

7. The image processing apparatus according to claim 1, further comprising:
a plurality of the 2D video generation units,
wherein a plurality of the 2D video generation units acquires, as the virtual viewpoint information, pieces of camera positional information from different cameras, and generates 2D videos.

8. The image processing apparatus according to claim 1, further comprising:
a plurality of the 2D video generation units,
wherein a plurality of the 2D video generation units acquires, as the virtual viewpoint information, camera positional information from the same camera, and generates 2D videos.

9. The image processing apparatus according to claim 1, further comprising:
a plurality of video synthesizing units that synthesizes 2D videos generated by a plurality of the 2D video generation units and 2D videos imaged by a plurality of the cameras.

10. The image processing apparatus according to claim 9, further comprising:
a selection unit that selects any one of a plurality of synthesized images generated by the plurality of video synthesizing units, and outputs the selected synthesized image.

11. The image processing apparatus according to claim 1, wherein the camera is a camera that outputs a 2D video and a depth video.

12. The image processing apparatus according to claim 1, wherein an imaging system including the camera includes a mode selection unit that switches between a mode in which an origin position moves in conjunction with movement of the camera, a mode in which the origin position is fixed, and a mode in which the origin position is able to be corrected.

13. The image processing apparatus according to claim 1, wherein the camera includes a camera of a smartphone.

14. The image processing apparatus according to claim 1, wherein the camera includes a camera of a drone.

15. The image processing apparatus according to claim 1, wherein the 2D video generation unit acquires illumination information of the first place, and outputs the acquired illumination information to an illumination control device that controls an illumination device at the second place.

16. The image processing apparatus according to claim 1, wherein an imaging system including the camera includes a second camera that images a periphery of the camera, and a video of the second camera is configured to be displayed on a display of the second place.

17. The image processing apparatus according to claim 1, wherein the 2D video generation unit acquires the virtual viewpoint information by using a FreeD protocol.

18. An image processing system comprising:
a 2D video generation device that acquires, as virtual viewpoint information, camera positional information of a camera that performs imaging at a first place, and generates a 2D video obtained by viewing a 3D model of a person generated by performing imaging at a second place different from the first place from a viewpoint of the camera; and
a video synthesizing device that generates a synthesized image obtained by synthesizing a 2D video generated by the 2D video generation device and a 2D video generated by the camera.
